(19) United States
(12) Patent Application Publication
(10) Pub. No.: US 2025/0133475 A1
(43) Pub. Date: Apr. 24, 2025

(54) LOCAL ROUTING IN NON-TERRESTRIAL NETWORK (NTN) ACCESS

(71) Applicant: Nokia Technologies Oy, Espoo (FI)

(72) Inventors: Ranganathan MAVUREDDI DHANASEKARAN, Munich (DE); Divya G NAIR, Bangalore (IN)

(21) Appl. No.: 18/916,606

(22) Filed: Oct. 15, 2024

(30) Foreign Application Priority Data
Oct. 19, 2023 (IN) 202311071521

(51) Int. Cl. H04W 40/22; H04W 12/106; H04W 84/06

(52) U.S. Cl. CPC H04W 40/22; H04W 12/106; H04W 84/06

(57) ABSTRACT

Local routing of data packets in a Next Generation Radio Access Network (NG-RAN). In an embodiment, a non-terrestrial network (NTN) satellite is operatively coupled to first and second User Equipment (UE). The NTN satellite is configured to store a UE context mapping between a first UE context of the first UE and a second UE context of the second UE, receive a data packet from the first UE over a first service link, determine whether to perform local routing of the data packet without routing to a ground network, and send the data packet to the second UE over a second service link based on the UE context mapping in response to a determination to perform local routing.

### TECHNICAL FIELD

This disclosure is related to the field of communication systems and, in particular, to next generation networks.

### BACKGROUND

Next generation networks, such as Fifth Generation (5G), denote the next major phase of mobile telecommunications standards beyond Fourth Generation (4G) standards. In comparison to 4G networks, next generation networks may be enhanced in terms of radio access and network architecture. Next generation networks intend to utilize new regions of the radio spectrum for Radio Access Networks (RANs), such as millimeter wave bands.

With mobile networks widely used across the country and the world, communications may be intercepted or suffer from other kinds of attacks. To ensure security and privacy, the 3rd Generation Partnership Project (3GPP) has set forth security mechanisms for 5G mobile networks, and the security procedures performed within the 5G mobile networks. Due to the importance of security in 5G systems and beyond, it is desirable to continue to develop more robust security mechanisms.

One type of access supported in Next Generation (NG) RANs is Non-Terrestrial Network (NTN) access. For example, NTN access may comprise one or more NTN satellites configured to communicate with User Equipment (UE). Conditions may arise where NTN satellites become disconnected from the ground network, which may interrupt communication between UEs.

### SUMMARY

Described herein is a local routing solution in NG-RANs. In general, an NG-RAN node, such as an NTN satellite, stores UE contexts for UEs that are accessing the NTN satellite (i.e., through a service link). The NTN satellite may be configured with a UE context mapping that links or correlates the UE context of a UE with the UE context of another UE. In response to receiving data packets from a UE, the NTN satellite may perform local routing of data packets to another UE based on the UE context mapping, without routing the data packets to the ground network. One technical benefit is the NTN satellite may support communications between UEs even in scenarios where a radio or feeder link to the ground network is disconnected. Another technical benefit is the NTN satellite may support security mechanisms to protect the data packets based on the UE contexts for the UEs.

In an embodiment (also referred to as an aspect), an apparatus of a RAN (e.g., NG-RAN) comprises a non-terrestrial network (NTN) satellite operatively coupled to a first UE and a second UE. The NTN satellite comprises at least one processor, and at least one memory storing instructions that, when executed by the at least one processor, cause the NTN satellite at least to store a UE context mapping between a first UE context of the first UE and a second UE context of the second UE, receive a data packet from the first UE over a first service link, determine whether to perform local routing of the data packet without routing to a ground network, and send, in response to a determination to perform local routing, the data packet to the second UE over a second service link based on the UE context mapping.

In an embodiment, the at least one processor further causes the NTN satellite at least to determine whether a feeder link to the ground network is available, and decide to perform the local routing when the feeder link is unavailable.

In an embodiment, the at least one processor further causes the NTN satellite at least to integrity protect the data packet based on an integrity key indicated in the second UE context of the second UE before sending to the second UE.

In an embodiment, the at least one processor further causes the NTN satellite at least to encrypt the data packet based on an encryption key indicated in the second UE context of the second UE before sending to the second UE.

In an embodiment, the data packet comprises one of radio resource control signaling or user plane traffic.

In an embodiment, the at least one processor further causes the NTN satellite at least to receive a context management message of a context management procedure from an access and mobility management function indicating the UE context mapping, where the context management procedure comprises an initial context setup procedure.

In an embodiment, an initial context setup request message of the initial context setup procedure is extended to include an information element containing the UE context mapping.

In an embodiment, the UE context mapping includes a mapping link from the first UE context to the second UE context, and the mapping link comprises a radio network temporary identifier assigned to the second UE.

In an embodiment, the UE context mapping includes a mapping link from the first UE context to the second UE context, and the mapping link comprises a UE radio access network identifier assigned to the second UE.

In an embodiment, the at least one processor further causes the NTN satellite at least to identify a handover scenario to another NTN satellite, and forward the UE context mapping to the other NTN over an inter-satellite link.

In an embodiment, a method of performing local routing in a radio access network comprises storing, at an NTN satellite operatively coupled to a first UE and a second UE, a UE context mapping between a first UE context of the first UE and a second UE context of the second UE, receiving a data packet from the first UE over a first service link, determining whether to perform local routing of the data packet without routing to a ground network, and sending, in response to a determination to perform local routing, the data packet from the NTN satellite to the second UE over a second service link based on the UE context mapping.

In an embodiment, the determining whether to perform local routing of the data packet comprises determining whether a feeder link to the ground network is available, and deciding to perform the local routing when the feeder link is unavailable.

In an embodiment, the method further comprises integrity protecting the data packet based on an integrity key indicated in the second UE context of the second UE before sending to the second UE.

In an embodiment, the method further comprises encrypting the data packet based on an encryption key indicated in the second UE context of the second UE before sending to the second UE.

In an embodiment, the method further comprises identifying a handover scenario to another NTN satellite, and forwarding the UE context mapping to the other NTN satellite over an inter-satellite link.

In an embodiment, an apparatus of a radio access network comprises an NTN satellite operatively coupled to a first UE and a second UE. The NTN satellite comprises a means for storing a UE context mapping between a first UE context of the first UE and a second UE context of the second UE, a means for receiving a data packet from the first UE over a first service link, a means for determining whether to perform local routing of the data packet without routing to a ground network, and a means for sending, in response to a determination to perform local routing, the data packet to the second UE over a second service link based on the UE context mapping.

In an embodiment, the means for determining comprises a means for determining whether a feeder link to the ground network is available, and a means for deciding to perform the local routing when the feeder link is unavailable.

In an embodiment, the NTN satellite further comprises a means for integrity protecting the data packet based on an integrity key indicated in the second UE context of the second UE before sending to the second UE.

In an embodiment, the NTN satellite further comprises a means for encrypting the data packet based on an encryption key indicated in the second UE context of the second UE before sending to the second UE.

In an embodiment, the data packet comprises one of radio resource control signaling or user plane traffic.

In an embodiment, the NTN satellite further comprises a means for receiving a context management message of a context management procedure from an access and mobility management function indicating the UE context mapping, where the context management procedure comprises an initial context setup procedure.

In an embodiment, an initial context setup request message of the initial context setup procedure is extended to include an information element containing the UE context mapping.

In an embodiment, the UE context mapping includes a mapping link from the first UE context to the second UE context, and the mapping link comprises a radio network temporary identifier assigned to the second UE.

In an embodiment, the UE context mapping includes a mapping link from the first UE context to the second UE context, and the mapping link comprises a UE radio access network identifier assigned to the second UE.

In an embodiment, the NTN satellite further comprises a means for identifying a handover scenario to another NTN satellite, and a means for forwarding the UE context mapping to the other NTN satellite over an inter-satellite link.

Other embodiments may include computer readable media, other systems or apparatus, or other methods as described below. Also, one or more embodiments as described above may be combinable as described herein.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a high-level architecture of a 5G system.

FIG. 2 illustrates a non-roaming architecture of a 5G system.

FIG. 3 illustrates security mechanisms within a 5G system.

FIGS. 4A-4B illustrate the primary authentication procedure that provides mutual authentication between user equipment and the network.

FIG. 5 illustrates non-access stratum (NAS) and access stratum (AS) security procedures.

FIG. 6 illustrates user plane (UP) security activation.

FIG. 7 illustrates a key hierarchy of a 5G system.

FIGS. 8A-8B illustrate NTN-based NG-RAN architectures.

FIG. 9 illustrates local routing of data packets in an illustrative embodiment.

FIG. 10 is a block diagram of an NG-RAN node in an illustrative embodiment.

FIG. 11 is a block diagram of a UE in an illustrative embodiment.

FIG. 12 is a block diagram of an AMF in an illustrative embodiment.

FIG. 13 is a flow chart illustrating a method of performing local routing in an NG-RAN in an illustrative embodiment.

FIG. 14 illustrates a local routing scenario in an illustrative embodiment.

FIG. 15 is a flow chart illustrating a method of determining whether to perform local routing in an illustrative embodiment.

FIG. 16 illustrates inter-satellite communication in an illustrative embodiment.

FIG. 17 is a flow chart illustrating a method of forwarding a UE context mapping in a mobility scenario in an illustrative embodiment.

FIGS. 18A-18B illustrate local routing of control plane messages in an illustrative embodiment.

FIG. 19 illustrates a control plane protocol stack in an illustrative embodiment.

FIG. 20 is a message diagram illustrating local routing of control plane messages in an illustrative embodiment.

FIGS. 21A-21B illustrate local routing of user plane messages in an illustrative embodiment.

FIG. 22 illustrates a user plane protocol stack in an illustrative embodiment.

FIG. 23 is a message diagram illustrating local routing of user plane messages in an illustrative embodiment.

FIG. 24 illustrates an initial context setup procedure in an illustrative embodiment.

FIG. 25 illustrates an initial context setup request message in an illustrative embodiment.

FIG. 26 illustrates a UE context modification procedure in an illustrative embodiment.

FIG. 27 illustrates a UE context modification request message in an illustrative embodiment.

FIGS. 28A-28C illustrate mapping of UE contexts in illustrative embodiments.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

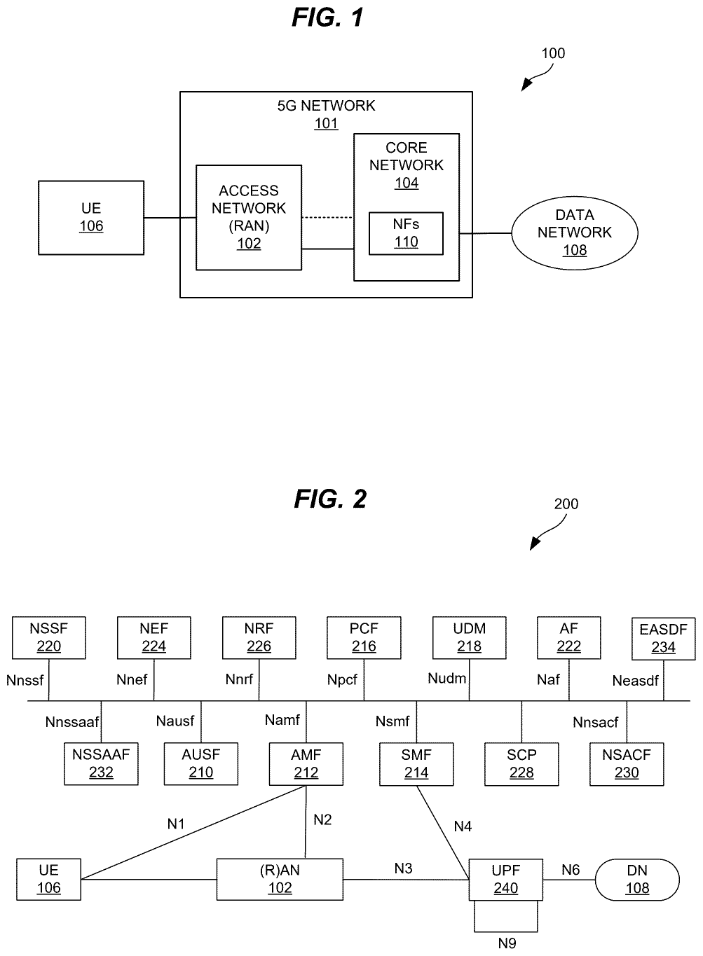

FIG. 1 illustrates a high-level architecture of a 5G system 100. A 5G system (5GS) 100 is a communication system (e.g., a 3GPP system) comprising a 5G Access Network ((R)AN) 102 (referred to herein generally as a RAN) and a 5G core network (5GC) 104 that communicate with 5G User Equipment (UE) 106. The RAN 102 and 5GC 104 together may be referred to as a 5G network 101, a 5G mobile network, a 5G communication network, etc. Although the term “5G” is used herein, any next generation networks beyond 5G are also considered.

RAN 102 provides radio or wireless connectivity to a UE 106, and connects the UE 106 to the 5GC 104. RAN 102 may comprise a Next Generation Radio Access Network (NG-RAN), a non-3GPP access network, and/or another type of RAN connecting to 5GC 104. RAN 102 may support Evolved-UMTS Terrestrial Radio Access Network (E-UTRAN) access (e.g., through an eNodeB (eNB), gNodeB (gNB), and/or ng-eNodeB (ng-eNB)), Wireless Local Area Network (WLAN) access, satellite radio access, new Radio Access Technologies (RAT), etc. A 5G access network may also support fixed access. 5GC 104 interconnects RAN 102 with a data network (DN) 108. 5GC 104 is comprised of Network Functions (NF) 110, which may be implemented either as a network element on dedicated hardware, as a software instance running on dedicated hardware, as a virtualized function instantiated on an appropriate platform (e.g., a cloud infrastructure), etc. Data network 108 may be an operator external public or private data network, or an intra-operator data network (e.g., for IP Multimedia Subsystem (IMS) services). A UE 106 (also referred to as a mobile terminal) includes a 5G capable device configured to register with 5GC 104 to access services. UE 106 may include an end user device, such as a mobile phone (e.g., smartphone), a tablet, a computer with a mobile broadband adapter, etc. UE 106 may be enabled for voice services, data services, Machine-to-Machine (M2M) or Machine Type Communications (MTC) services, and/or other services.

FIG. 2 illustrates a non-roaming architecture 200 of a 5G system 100. The architecture 200 in FIG. 2 is a service-based representation, as is further described in 3GPP TS 23.501 (v18.2.0), which is incorporated by reference as if fully included herein. Architecture 200 is comprised of Network Functions (NF) for a 5GC 104, and the NFs for the control plane (CP) are separated from the user plane (UP). The control plane of the 5GC 104 includes an Authentication Server Function (AUSF) 210, an Access and Mobility Management Function (AMF) 212, a Session Management Function (SMF) 214, a Policy Control Function (PCF) 216, a Unified Data Management (UDM) 218, a Network Slice Selection Function (NSSF) 220, and an Application Function (AF) 222. The control plane of the 5GC 104 further includes a Network Exposure Function (NEF) 224, a NF Repository Function (NRF) 226, a Service Communication Proxy (SCP) 228, a Network Slice Admission Control Function (NSACF) 230, a Network Slice-specific and SNPN Authentication and Authorization Function (NSSAAF) 232, and an Edge Application Server Discovery Function (EASDF) 234. The user plane of the 5GC 104 includes one or more User Plane Functions (UPF) 240 that communicate with data network 108. A UE 106 is able to access the control plane and the user plane of the 5GC 104 through RAN 102.

There are a large number of subscribers that are able to access services from a carrier or home network operator that implements a mobile network comprising a 5G system 100, such as in FIGS. 1-2. Communications between the subscribers (i.e., through a UE) and the mobile network are protected by security mechanisms, such as the ones standardized by the 3GPP. Subscribers and the carrier expect security guarantees from the security mechanisms.

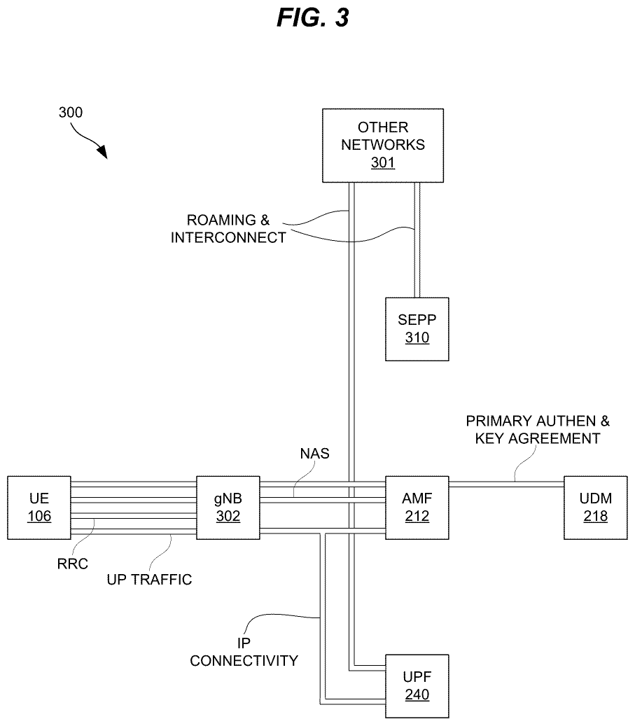

FIG. 3 illustrates security mechanisms 300 within a 5G system 100. One of the security mechanisms 300 is primary authentication and key agreement between the network (e.g., AMF 212/UDM 218) and the UE 106. Other security mechanisms 300 are used to protect signaling between the network and the UE 106. For example, a security mechanism 300 is used to protect Non-Access Stratum (NAS) signaling between the AMF 212 and the UE 106. Another security mechanism 300 is used to protect Radio Resource Control (RRC) signaling between a gNB 302 and the UE 106. A security mechanism 300 may also be used to protect User Plane (UP) traffic (also referred to as UP data) between the gNB 302 and the UE 106. Within the network, a security mechanism 300 may be used to protect IP connectivity between the gNB 302 and the 5GC 104 (e.g., AMF 212/UPF 240), such as Internet Protocol Security (IPSec). Yet another security mechanism 300 is used for roaming and interconnect security, such as to protect control plane signaling between a Security Edge Protection Proxy (SEPP) 310 and another network 301 (e.g., a visited 5G network), and/or to protect user plane data between the UPF 240 and the other network 301. There may be additional security mechanisms 300 defined or used, which are not discussed for the sake of brevity.

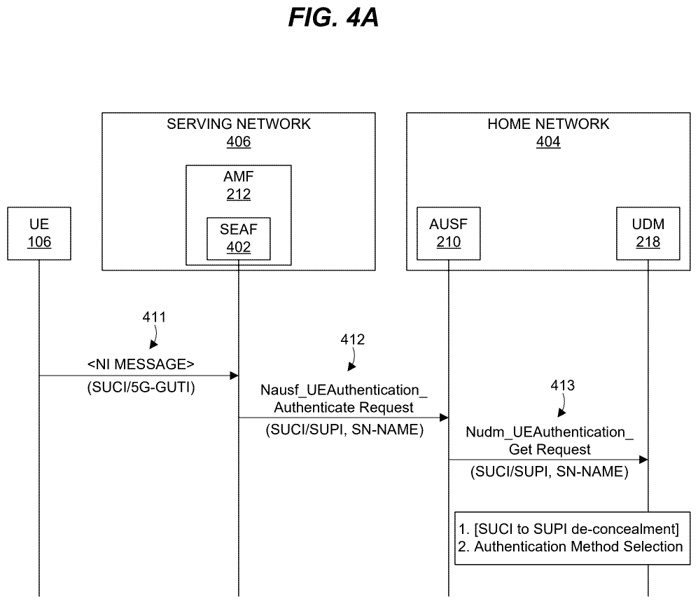

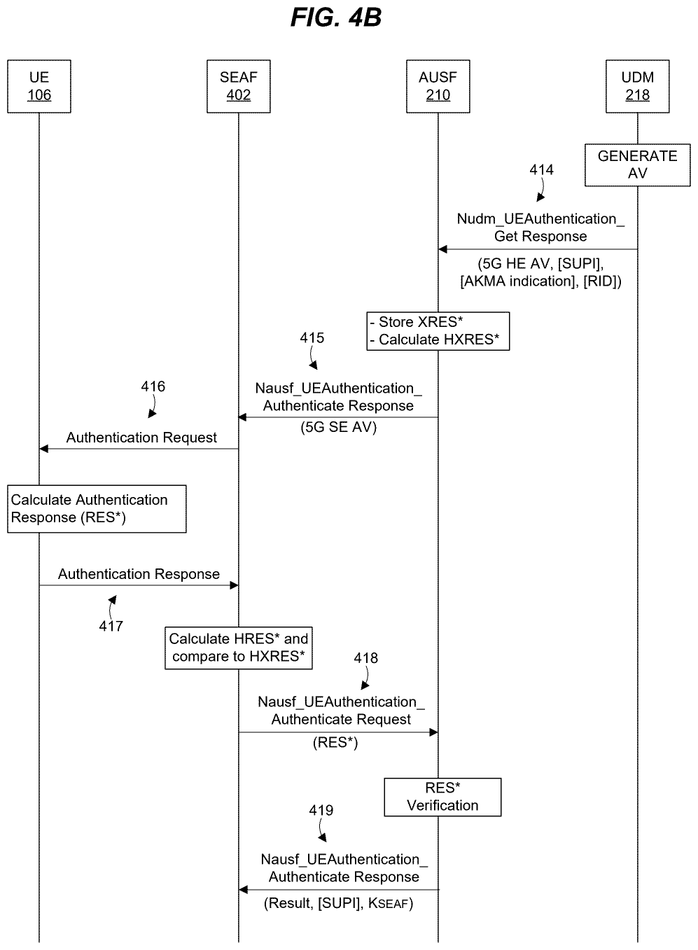

FIGS. 4A-4B illustrate the primary authentication procedure that provides mutual authentication between the UE 106 and the network (e.g., AMF 212/UDM 218). The purpose of the primary authentication and key agreement procedures is to enable mutual authentication between UE 106 and the home network of the UE 106, and provide keying material that can be used between the UE 106 and the serving network in subsequent security procedures (e.g., NAS and AS security procedures). The home network (e.g., Home Public Land Mobile Network (HPLMN)) represents an operator network or carrier network through which a subscriber (e.g., UE 106) has a subscription for services. The serving network has radio access equipment able to communicate with the UE 106 via radio signals. The keying material generated by the primary authentication and key agreement procedure results in an anchor key (called the K_{SEAF} key) provided by the AUSF 210 of the home network to the Security Anchor Function (SEAF) of the serving network. The SEAF provides authentication functionality via the AMF 212 in the serving network, and supports primary authentication using a Subscription Concealed Identifier (SUCI) that contains the concealed Subscription Permanent Identifier (SUPI). The SUPI is a globally unique 5G identifier allocated to each subscriber in the 5G system 100. The SUCI is composed of a SUPI type, a Home Network Identifier (HN-ID) identifying the home network of the subscriber, a Routing Indicator (RID) that is assigned to the subscriber by the home network operator and provisioned in the Universal Subscriber Identity Module (USIM) of the UE 106, a Protection Scheme Identifier, a Home Network Public Key Identifier, and a Scheme Output. The anchor key (K_{SEAF}) is derived from an intermediate key called the K_{AUSF} key. The K_{AUSF} key is established between the UE 106 and the home network (AUSF 210) resulting from the primary authentication procedure.

FIG. 4A is a signaling diagram that illustrates initiation of primary authentication, such as described in 3GPP TS 33.501 (v18.2.0), which is incorporated by reference as if fully included herein. The UE 106 transmits an N1 message 411 (i.e., an initial NAS message) to the serving network 406 (e.g., the AMF 212 of the serving network 406), such as a Registration Request. The serving network 406 may also be referred to as a serving PLMN, a visited-PLMN (VPLMN), etc., in a roaming scenario. The UE 106 uses the SUCI or a 5G Global Unique Temporary Identifier (5G-GUTI) in the Registration Request. SEAF 402 of the AMF 212 may initiate an authentication with the UE 106 during any procedure establishing a signaling connection with the UE 106. SEAF 402 invokes the Nausf_UEAuthentication service toward the home network 404 (e.g., HPLMN) by sending a Nausf_UEAuthentication_Authenticate Request message 412 to AUSF 210 to initiate an authentication. The Nausf_UEAuthentication_Authenticate Request message 412 includes the SUCI or SUPI, and the serving network name (SN-Name). Upon receiving the Nausf_UEAuthentication_Authenticate Request message 412, AUSF 210 checks that the requesting SEAF 402 in the serving network 406 is entitled to use the serving network name (SNN) in the Nausf_UEAuthentication_Authenticate Request message 412 by comparing the serving network name with the expected serving network name. When the serving network 406 is authorized to use the serving network name, AUSF 210 sends a Nudm_UEAuthentication_Get Request message 413 to UDM 218 of the home network. The Nudm_UEAuthentication_Get Request message 413 includes the SUCI or SUPI, and the serving network name. Upon reception of the Nudm_UEAuthentication_Get Request message 413, UDM 218 identifies the SUPI (if received), or invokes a Subscription Identifier De-concealing Function (SIDF) that de-conceals the SUPI from the SUCI (if received). UDM 218 (or an Authentication credential Repository and Processing Function (ARPF) of UDM 218) selects or chooses the authentication method for primary authentication based on the SUPI.

FIG. 4B is a signaling diagram that illustrates a primary authentication procedure, such as described in 3GPP TS 33.501. In this example, 5G Authentication and Key Agreement (AKA) is described, but similar concepts apply for Extensible Authentication Protocol AKA prime (EAP-AKA′). For a Nudm_UEAuthentication_Get Request 413, UDM 218 creates a 5G Home Environment Authentication Vector (5G HE AV) for the selected authentication method. UDM 218 derives the K_{AUSF} key and calculates an expected response (XRES*) to a challenge. UDM 218 creates the 5G HE AV comprising an authentication token (AUTN), the expected response (XRES*), the K_{AUSF} key, and a random challenge (RAND). UDM 218 then sends a Nudm_UEAuthentication_Get Response message 414 to AUSF 210 with the 5G HE AV to be used for authentication (e.g., 5G AKA in FIG. 4B). In case the SUCI was included in the Nudm_UEAuthentication_Get Request 413, UDM 218 includes the SUPI in the Nudm_UEAuthentication_Get Response message 414 after de-concealment of the SUPI from the SUCI. If a subscriber has an Authentication and Key Management for Application (AKMA) subscription, UDM 218 may include an AKMA indication and the RID in the Nudm_UEAuthentication_Get Response message 414.

In response to the Nudm_UEAuthentication_Get Response message 414, AUSF 210 stores the expected response (XRES*) temporarily with the received SUCI or SUPI. AUSF 210 then generates a 5G Authentication Vector (5G AV) from the 5G HE AV received from UDM 218, by computing a hash expected response (HXRES*) from the expected response (XRES*) and the K_{SEAF} key from the K_{AUSF} key, and replacing the XRES* with the HXRES* and the K_{AUSF} key with the K_{SEAF} key in the 5G HE AV. AUSF 210 removes the K_{SEAF} key to generate a 5G Serving Environment Authentication Vector (5G SE AV) that includes the authentication token (AUTN), hash expected response (HXRES*), and the random challenge (RAND). AUSF 210 sends a Nausf_UEAuthentication_Authenticate Response message 415 to SEAF 402 that includes the 5G SE AV. In response, SEAF 402 sends the authentication token (AUTN) and the random challenge (RAND) to the UE 106 in a NAS message Authentication Request message 416.

Although not shown in FIG. 4B, the UE 106 includes Mobile Equipment (ME) and a USIM. The ME receives the authentication token (AUTN) and the random challenge (RAND) in the NAS message Authentication Request message 416, and forwards the authentication token (AUTN) and the random challenge (RAND) to the USIM. The USIM of the UE 106 verifies the freshness of the received values by checking whether the authentication token (AUTN) can be accepted. If so, the USIM computes a response (RES), a cipher key (CK), and an integrity key (IK) based on the random challenge (RAND), and returns the response (RES), the CK key, and the IK key to the ME. The ME of the UE 106 computes RES* from RES, and calculates the K_{AUSF} key from CK∥IK and the K_{SEAF} key from the K_{AUSF} key.

The UE 106 sends a NAS message Authentication Response message 417 to SEAF 402 that includes RES*. In response, SEAF 402 computes HRES* from RES*, and compares HRES* and HXRES*. If they coincide, SEAF 402 considers the authentication successful from the serving network point of view. SEAF 402 sends RES*, as received from the UE 106, in a Nausf_UEAuthentication_Authenticate Request message 418 to AUSF 210. When AUSF 210 receives the Nausf_UEAuthentication_Authenticate Request message 418 including a RES* as authentication confirmation, AUSF 210 stores the K_{AUSF} key based on the home network operator's policy, and compares the received RES* with the stored XRES*. If the RES* and XRES* are equal, then AUSF 210 considers the authentication successful from the home network point of view. AUSF 210 informs UDM 218 about the authentication result (not shown). AUSF 210 also sends a Nausf_UEAuthentication_Authenticate Response message 419 to SEAF 402 indicating whether or not the authentication was successful from the home network point of view. If the authentication was successful, the K_{SEAF} key is sent to SEAF 402 in the Nausf_UEAuthentication_Authenticate Response message 419. In case AUSF 210 received the SUCI from SEAF 402 in the authentication request, AUSF 210 includes the SUPI in the Nausf_UEAuthentication_Authenticate Response message 419 if the authentication was successful.

As described above, 5G divides UE management into the Non-Access Stratum (NAS) and the Access Stratum (AS). The NAS layer protocol manages the connection between a UE 106 and 5GC 104 (i.e., AMF 212), and the AS layer protocol manages the radio layer between a UE 106 and the RAN 102 (e.g., gNB 302) using RRC protocol. NAS security ensures that NAS signaling between a UE 106 and AMF 212 is protected on the control plane, and AS security ensures that RRC messages on the control plane and user plane traffic (e.g., IP packets) on the user plane are protected.

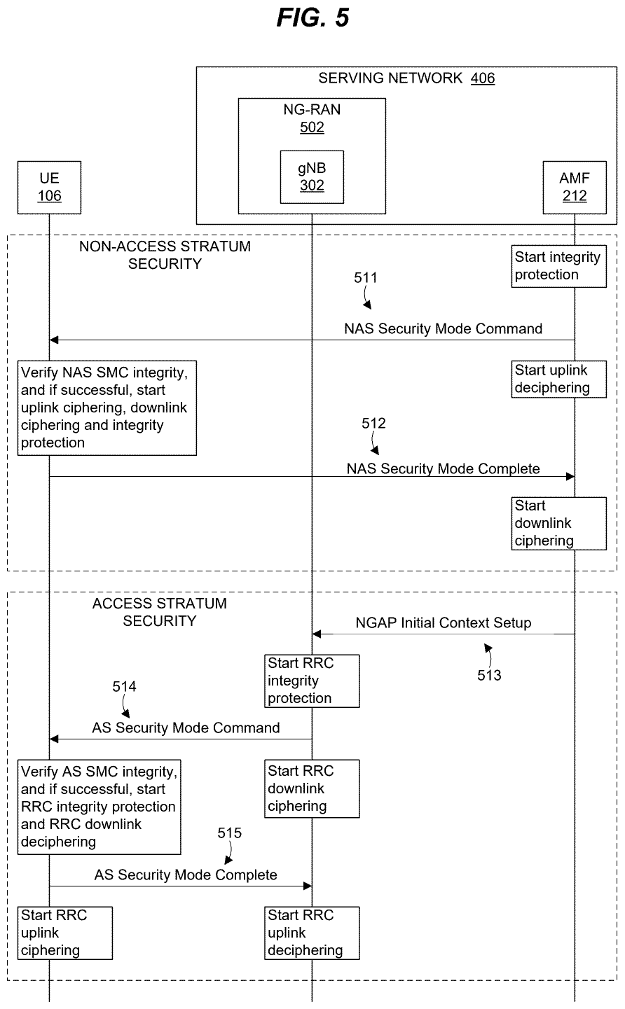

FIG. 5 illustrates NAS and AS security procedures, such as described in 3GPP TS 33.501 (sections 6.4 and 6.7, respectively). For NAS security, a NAS security mode command procedure is performed to establish a NAS security context between the UE 106 and the AMF 212. Each AMF 212 is configured via network management with lists of algorithms that are allowed for usage. Presently, there is one list for NAS integrity algorithms and one for NAS ciphering algorithms that are ordered according to a priority decided by the operator. To establish the NAS security context, AMF 212 selects one NAS ciphering algorithm and one NAS integrity protection algorithm, and derives the NAS integrity key and the NAS encryption key (e.g., K_{NASint} and K_{NASenc}) for the selected algorithms. AMF 212 initiates the NAS security mode command procedure by sending a NAS Security Mode Command message 511 to the UE 106. AMF 212 activates NAS integrity protection before sending the NAS Security Mode Command message 511. The NAS Security Mode Command message 511 contains the previously received UE security capabilities, the selected NAS algorithms, a key set identifier (i.e., ngKSI (next generation key set identifier)), and a message authentication code (NAS-MAC) generated by the AMF 212 for integrity protection of the NAS Security Mode Command message 511. The NAS Security Mode Command message 511 is integrity protected (but not ciphered) with the NAS integrity key based on the K_{AMF} key indicated by the ngKSI. AMF 212 activates NAS uplink de-ciphering after sending the NAS Security Mode Command message 511.

On receipt of the NAS Security Mode Command message 511, the UE 106 verifies the integrity of the NAS Security Mode Command using the indicated NAS integrity algorithm and the NAS integrity key based on the K_{AMF} key indicated by the ngKSI. The UE 106, with the received algorithms, generates the NAS integrity key and the NAS encryption key in the same manner as AMF 212. If verification is successful, the UE 106 begins NAS integrity protection and ciphering/deciphering with the security context indicated by the ngKSI. The UE 106 sends a NAS Security Mode Complete message 512 to AMF 212 that is ciphered and integrity protected. If the verification of the NAS Security Mode Command message 511 is not successful, the UE 106 replies with a NAS Security Mode Reject message (not shown).

AMF 212 de-ciphers and checks the integrity of the received NAS Security Mode Complete message 512 using the key and algorithm indicated in the NAS Security Mode Command message 511. AMF 212 activates NAS downlink ciphering after receiving the NAS Security Mode Complete message 512.

AS security includes RRC security and User Plane (UP) security. For RRC security, RRC integrity protection and RRC confidentiality protection are provided by the Packet Data Convergence Protocol (PDCP) layer between a UE 106 and a gNB 302. For UP security, the SMF 214 provides a UP security policy for a Packet Data Unit (PDU) session to the gNB 302 (or ng-eNB) during the PDU session establishment procedure (not shown). The UP security policy indicates whether UP confidentiality and/or UP integrity protection are activated for Data Radio Bearers (DRBs) belonging to that PDU session.

An AS security mode command procedure is performed to establish an AS security context between the UE 106 and the NG-RAN 502. When the AS security context is to be established in the gNB 302, AMF 212 sends the UE 5G security capabilities with ciphering and integrity protected algorithms and the K_{gNB} key in an NG Application Protocol (NGAP) Initial Context Setup message 513 to the NG-RAN 502 (e.g., gNB 302). Presently, each gNB 302 is configured via network management with lists of algorithms that are allowed for usage. There is one list for integrity algorithms and one for ciphering algorithms that are ordered according to a priority decided by the operator. The gNB 302 selects the AS integrity algorithm and the AS ciphering algorithm which has the highest priority from its configured list and present in the UE 5G security capabilities received from AMF 212. The gNB 302 derives the RRC integrity key (K_{RRCint}), the UP integrity key (K_{UPint}), the RRC ciphering key (K_{RRCenc}), and the UP ciphering key (K_{UPenc}) for the selected AS algorithms. The gNB 302 starts integrity protection for RRC messages.

The gNB 302 sends an integrity protected AS Security Mode Command message 514 to the UE 106, which contains the selected AS integrity algorithm and AS ciphering algorithm, and the message authentication code (MAC-I) generated by the gNB 302 for integrity protection of the AS Security Mode Command message 514. RRC downlink ciphering at the gNB 302 starts after sending the AS Security Mode Command message 514.

On receipt of the AS Security Mode Command message 514, the UE 106 derives the RRC integrity key (K_{RRCint}) and the RRC ciphering key (K_{RRCenc}) similar to the gNB 302 based on the selected AS integrity algorithm and AS ciphering algorithm. UE 106 verifies the AS Security Mode Command integrity and, if successful, starts RRC integrity protection and RRC downlink de-ciphering. The UE 106 then sends an AS Security Mode Complete message 515 with integrity protection to the gNB 302. The AS Security Mode Complete message 515 contains the MAC-I generated by UE 106 for integrity protection of the AS Security Mode Complete message 515. The RRC uplink ciphering at the UE 106 starts after sending the AS Security Mode Complete message 515. Integrity of the AS Security Mode Complete message 515 is verified at the gNB 302, and the gNB 302 starts RRC uplink deciphering.

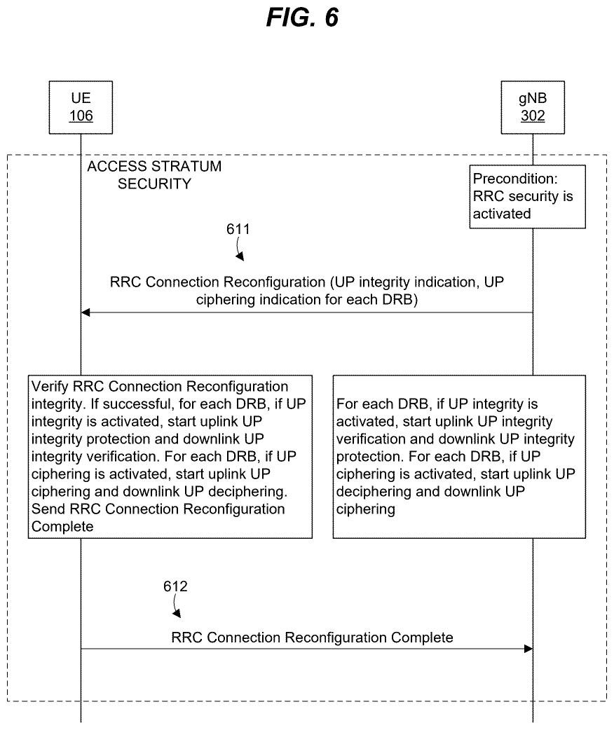

Further, as part of AS security, FIG. 6 illustrates UP security activation. The AS UP integrity protection and ciphering activation is done as part of the DRB addition procedure using the RRC Connection Reconfiguration procedure. The RRC Connection Reconfiguration procedure, which is used to add DRBs, is performed after RRC security has been activated as part of the AS security mode command procedure. The gNB 302 sends an RRC Connection Reconfiguration message 611 to the UE 106 for UP security activation. The RRC Connection Reconfiguration message 611 contains indications for the activation of UP integrity protection and UP ciphering for each DRB according to the security policy. If UP integrity protection is activated for DRBs as indicated in the RRC Connection Reconfiguration message 611 and the gNB 302 does not have the K_{UPint} key, the gNB 302 derives the K_{UPint} key and UP integrity protection for the DRBs starts at the gNB 302. Similarly, if UP ciphering is activated for DRBs as indicated in the RRC Connection Reconfiguration message 611 and the gNB 302 does not have the K_{UPenc} key, the gNB 302 derives the K_{UPenc} key and UP ciphering for DRBs starts at the gNB 302.

On receipt of the RRC Connection Reconfiguration message 611, the UE 106 verifies the RRC Connection Reconfiguration integrity protection. If successful, the UE 106 performs the following. When UP integrity protection is activated for DRBs as indicated in the RRC Connection Reconfiguration message 611 and the UE 106 does not have the K_{UPint} key, the UE 106 derives the K_{UPint} key and UP integrity protection for DRBs starts at the UE 106. Similarly, when UP ciphering is activated for DRBs as indicated in the RRC Connection Reconfiguration message 611 and the UE 106 does not have the K_{UPenc} key, the UE 106 derives the K_{UPenc} key and UP ciphering for DRBs starts at the UE 106. The UE 106 sends an RRC Connection Reconfiguration Complete message 612 to the gNB 302.

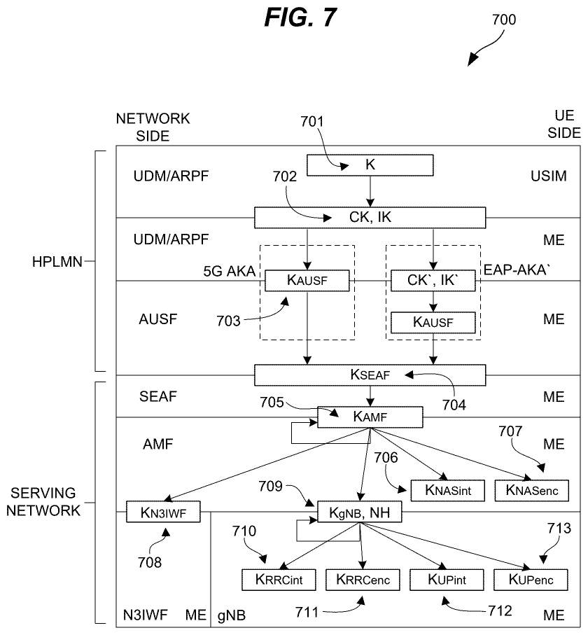

FIG. 7 illustrates a key hierarchy 700 of a 5G system 100, such as in 3GPP TS 33.501 (section 6.2). The keys related to authentication include the following keys: K 701, and CK/IK 702. The key hierarchy 700 includes the following keys: K_{AUSF} 703, K_{SEAF} 704, K_{AMF} 705, K_{NASint} 706, K_{NASenc} 707, K_{N3IWF} 708, K_{gNB} 709, K_{RRCint} 710, K_{RRCenc} 711, K_{UPint} 712, and K_{UPenc} 713. The keys for AUSF 210 in the home network 404 include the K_{AUSF} key 703 derived by the ME of a UE 106 and AUSF 210 from CK′, IK′ in case of EAP-AKA′, or by the ME and the ARPF of UDM 218 from CK, IK 702 in case of 5G AKA. The K_{SEAF} key 704 is the anchor key derived by the ME and AUSF 210 from the K_{AUSF} key 703. The key for AMF 212 in the serving network 406 is the K_{AMF} key 705 derived by the ME and the SEAF 402 from the K_{SEAF} key 704. The keys for NAS signaling (i.e., of a NAS security context) include the K_{NASint} key 706 derived by the ME and AMF 212 from the K_{AMF} key 705, which is used for integrity protection of NAS signaling with a particular integrity algorithm. The keys for NAS signaling also include the K_{NASenc} key 707 derived by the ME and AMF 212 from the K_{AMF} key 705, which is used for encryption of NAS signaling with a particular encryption algorithm. The key for the NG-RAN is the K_{gNB} key 709 derived by the ME and AMF 212 from the K_{AMF} key 705. For an AS security context, the keys for RRC signaling include the K_{RRCint} key 710 derived by the ME and the gNB 302 from the K_{gNB} key 709, which is used for integrity protection of RRC signaling with a particular integrity algorithm. The keys for RRC signaling further include the K_{RRCenc} key 711 derived by the ME and the gNB 302 from the K_{gNB} key 709, which is used for encryption of RRC signaling with a particular encryption algorithm. The keys for UP traffic include the K_{UPint} key 712 derived by the ME and the gNB 302 from the K_{gNB} key 709, which is used for integrity protection of UP traffic between the ME and the gNB 302 with a particular integrity algorithm. The keys for UP traffic further include the K_{UPenc} key 713 derived by the ME and the gNB 302 from the K_{gNB} key 709, which is used for encryption of UP traffic with a particular encryption algorithm. For non-3GPP access, the K_{N3IWF} key 708 is derived by the ME and the AMF 212 from the K_{AMF} key 705 for non-3GPP access. There are other keys as part of the key hierarchy 700 of a 5G system 100, which are not discussed for the sake of brevity.

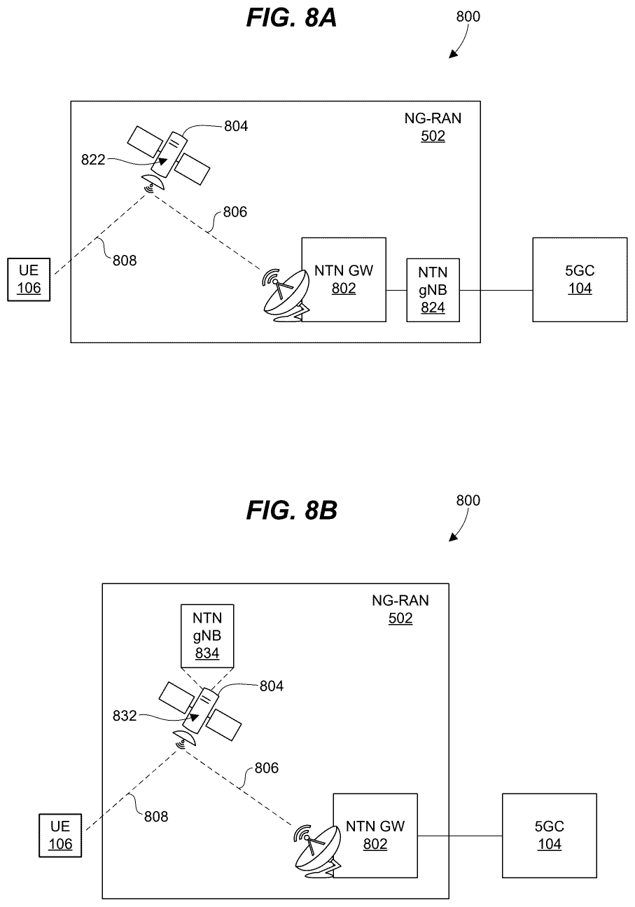

As described above, an NG-RAN 502 may support satellite access to a UE 106, which is also referred to as Non-Terrestrial Network (NTN) access. FIGS. 8A-8B illustrate NTN-based NG-RAN architectures 800. Non-terrestrial networks are networks, or segments of networks, using an airborne or space-borne vehicle to embark a transmission equipment relay node or base station. In the NTN-based NG-RAN architectures 800 of FIGS. 8A-8B, the NG-RAN 502 includes an NTN gateway 802, an NTN satellite 804, a feeder link 806 (or radio link) between the NTN gateway 802 and the NTN satellite 804, and a service link 808 (or radio link) between the UE 106 and the NTN satellite 804. NTN gateway 802 comprises an earth station or gateway located at the surface of Earth, which provides sufficient Radio Frequency (RF) power and RF sensitivity for accessing the NTN satellite 804. NTN gateway 802 connects to the 5GC 104. NTN satellite 804 is a space-borne vehicle placed into Low-Earth Orbit (LEO), Medium-Earth Orbit (MEO), or Geostationary Earth Orbit (GEO). NTN satellite 804 may implement either a transparent payload or a regenerative (with on-board processing) payload. A transparent payload performs RF filtering, frequency conversion, and amplification. Thus, the waveform signal repeated by the transparent payload is un-changed. A regenerative payload performs RF filtering, frequency conversion, and amplification, as well as demodulation/decoding, switching and/or routing, and coding/modulation. This is effectively equivalent to having all or part of the base station functions (e.g., gNB) on board the NTN satellite 804. In FIG. 8A, the NG-RAN 502 is based on a transparent satellite. Thus, NTN satellite 804 implements a transparent payload 822, and NG-RAN 502 includes a base station (referred to as NTN gNB 824 or on-ground NTN gNB 824) that is on-ground. In FIG. 8B, the NG-RAN 502 is based on a regenerative satellite. Thus, NTN satellite 804 implements a regenerative payload 832, and NG-RAN 502 includes a base station (referred to as NTN gNB 834 or on-board NTN gNB 834) that is on board NTN satellite 804. NTN-based NG-RAN architectures are further described in 3GPP TR 38.821 (v16.2.0), which is incorporated by reference as if fully included herein.

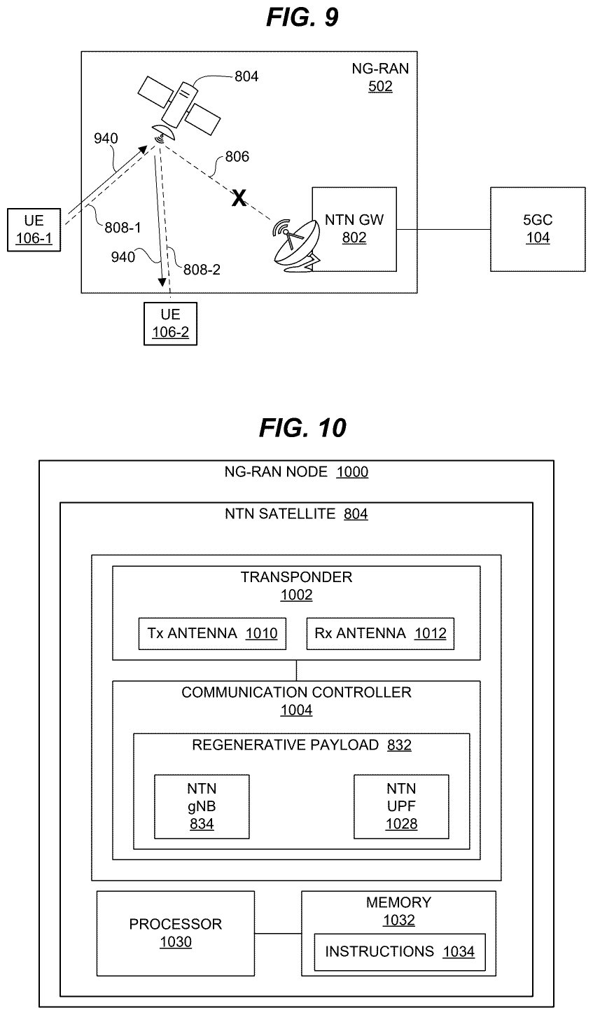

In embodiments described herein, the NG-RAN 502 (e.g., NTN satellite 804) and/or 5GC 104 are enhanced to provide local routing or local exchange of data packets (e.g., signaling and/or user plane traffic) between UEs 106 through the NTN satellite 804. FIG. 9 illustrates local routing of data packets in an illustrative embodiment. A service link 808-1 is established between UE 106-1 (i.e., a first UE) and NTN satellite 804, and a service link 808-2 is established between another UE 106-2 (i.e., a second UE) and the NTN satellite 804. When UE 106-1, for example, transmits or sends data packets 940 to NTN satellite 804 via service link 808-1, NTN satellite 804 is configured to perform local routing by sending or forwarding the data packets 940 to UE 106-2 directly over service link 808-2 without routing the data packets 940 to the 5GC 104. In an embodiment, NTN satellite 804 may be configured to perform local routing between UEs 106-1 and 106-2 when a feeder link 806 to NTN gateway 802 is unavailable.

Local routing via NTN satellite 804 is described in further detail below. In general, the mechanisms are implemented via an NG-RAN node (e.g., an NTN satellite 804), an AMF 212, and a UE 106. Block diagrams of these elements are provided below.

FIG. 10 is a block diagram of an NG-RAN node 1000 in an illustrative embodiment. One example of a NG-RAN node 1000 is an NTN satellite 804. In an embodiment, an NTN satellite 804 may include the following subsystems: a transponder 1002 and a communication controller 1004 that operate on one or more platforms. Transponder 1002 may comprise circuitry, logic, hardware, means, etc., configured to transmit and receive wireless or radio signals. In an embodiment, transponder 1002 includes one or more transmit (Tx) antennas 1010 configured to transmit wireless signals for reception by a UE 106, NTN gateway 802, etc. Transponder 1002 also includes one or more receive (Rx) antennas 1012 configured to receive wireless signals transmitted by a UE 106, NTN gateway 802, etc. Communication controller 1004 may comprise circuitry, logic, hardware, means, etc., configured to support operations, procedures, or functions of an NTN satellite 804. For example, communication controller 1004 may implement a regenerative payload 832. In an embodiment, regenerative payload 832 may comprise an NTN gNB 834, an on-board NTN UPF 1028, etc.

One or more of the subsystems of NTN satellite 804 may be implemented on a hardware platform comprised of analog and/or digital circuitry. One or more of the subsystems of NTN satellite 804 may be implemented on one or more processors 1030 that execute instructions 1034 (i.e., computer readable code) for software that are loaded into memory 1032. NTN satellite 804 may include various other components not specifically illustrated in FIG. 10. Other examples of NG-RAN node 1000 are Terrestrial Network (TN) nodes.

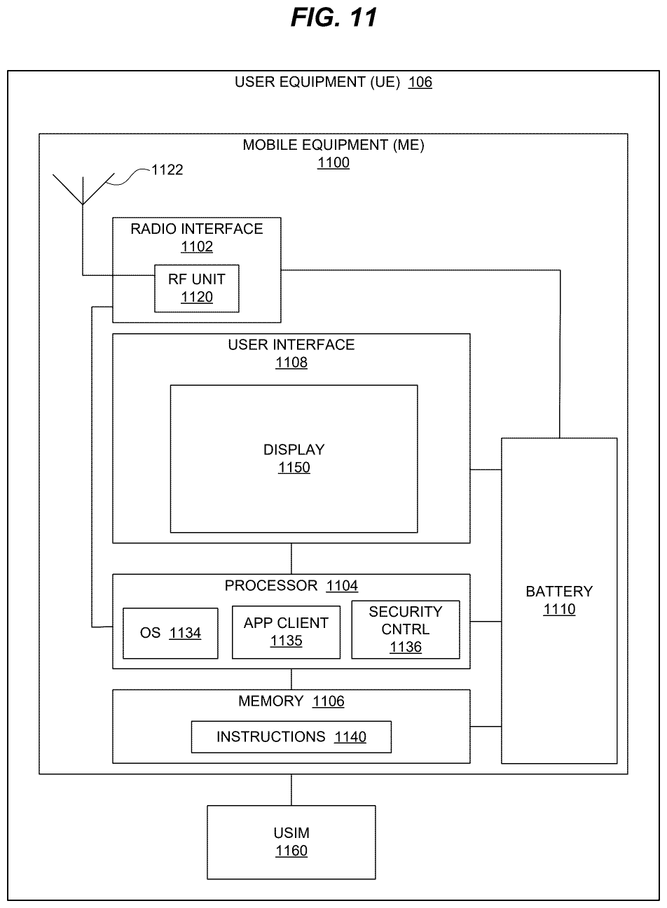

FIG. 11 is a block diagram of a UE 106 in an illustrative embodiment. From a functional standpoint, the UE 106 is composed of at least two parts: Mobile Equipment (ME) 1100 and a Universal Subscriber Identity Module (USIM) 1160. ME 1100 comprises a radio interface component 1102, one or more processors 1104, a memory 1106, and a user interface component 1108. The UE 106 may also comprise a battery 1110. Radio interface component 1102 is a hardware component or means that represents the local radio resources of the UE 106, such as a Radio Frequency (RF) unit 1120 (e.g., one or more radio transceivers) and one or more antennas 1122. Radio interface component 1102 may be configured for 5G New Radio (NR), Long Term Evolution (LTE), WiFi, Bluetooth, etc. Processor 1104 represents the internal circuitry, logic, hardware, means, etc., that provides the functions of the UE 106. Processor 1104 may be configured to execute instructions 1140 for software that are loaded into memory 1106. Processor 1104 may execute an Operating System (OS) 1134 for the UE 106 that manages hardware and software resources, and one or more application clients 1135. Processor 1104 may also execute a security controller 1136, which comprises a component or means for performing security mechanisms within the UE 106 (i.e., within the ME 1100). User interface component 1108 is a hardware component for interacting with an end user. For example, user interface component 1108 may comprise a display 1150, screen, touch screen, and/or the like (e.g., a Liquid Crystal Display (LCD), a Light Emitting Diode (LED) display, etc.). User interface component 1108 may include a keyboard or keypad, a tracking device (e.g., a trackball or trackpad), a speaker, a microphone, etc.

USIM 1160 is an integrated circuit that provides security and integrity functions for the UE 106. USIM 1160 includes or is provisioned with a subscription profile associated with a subscription of a subscriber. A subscription profile may include a variety of information, such as subscription credentials (e.g., SUPI) used to uniquely identify a subscription and to mutually authenticate the UE 106 and a network.

The UE 106 may comprise various other components not specifically illustrated in FIG. 11.

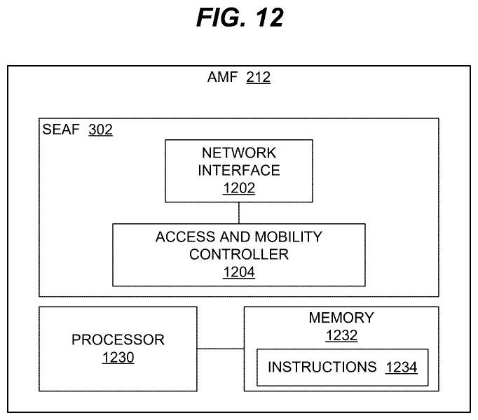

FIG. 12 is a block diagram of an AMF 212 in an illustrative embodiment. AMF 212 is a network element or network function configured provide registration management of a UE. In this embodiment, AMF 212 comprises the following subsystems: a network interface component 1202, and an access and mobility controller 1204 that operate on one or more platforms. Network interface component 1202 may comprise circuitry, logic, hardware, means, etc., configured to exchange control plane messages or signaling with other network elements and/or UEs. Network interface component 1202 may operate using a variety of protocols or reference points. Access and mobility controller 1204 may comprise circuitry, logic, hardware, means, etc., configured to support operations, procedures, or functions of an AMF.

One or more of the subsystems of AMF 212 may be implemented on a hardware platform comprised of analog and/or digital circuitry. One or more of the subsystems of AMF 212 may be implemented on one or more processors 1230 that execute instructions 1234 (i.e., computer readable code) for software that are loaded into memory 1232. One or more of the subsystems of AMF 212 may be implemented on a cloud-computing platform or another type of processing platform.

AMF 212 may comprise various other components not specifically illustrated in FIG. 12.

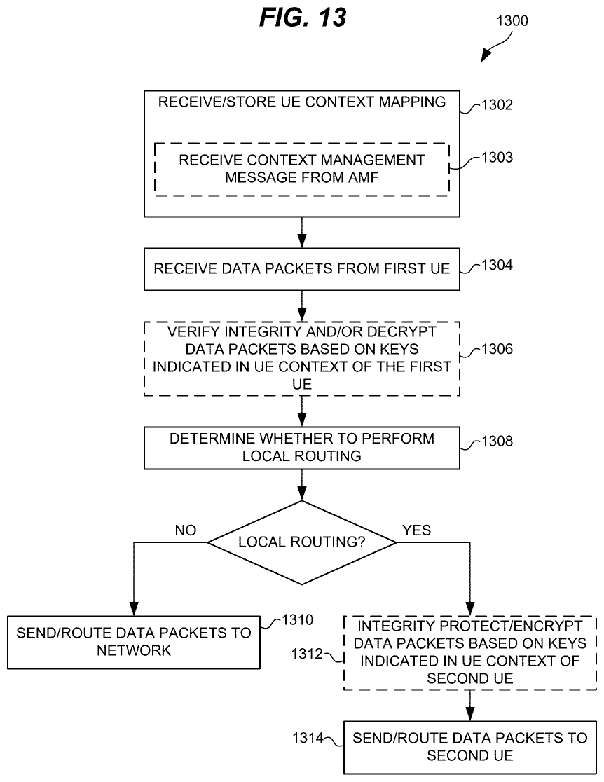

FIG. 13 is a flow chart illustrating a method 1300 of performing local routing in an NG-RAN 502 in an illustrative embodiment. The steps of method 1300 in FIG. 13 will be described with reference to NTN satellite 804 as shown in FIG. 10. Those skilled in the art will appreciate that method 1300 may be performed in other systems, devices, or network functions. For example, method 1300 may be performed in a terrestrial RAN node of NG-RAN 502. The steps of the flow charts described herein are not all inclusive and may include other steps not shown, and the steps may be performed in an alternative order.

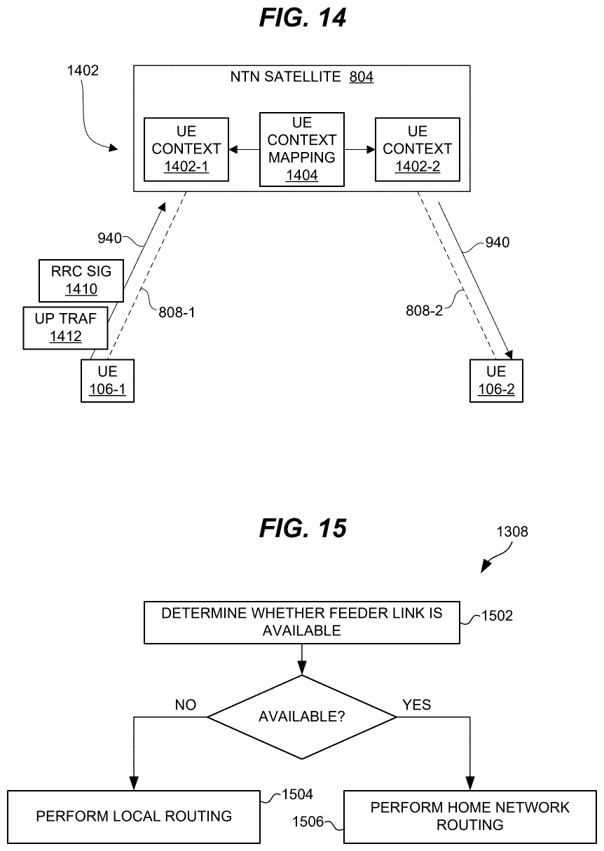

For method 1300, NTN satellite 804 is operatively or communicatively coupled to UE 106-1 and UE 106-2 via service links 808 (i.e., service links 808-1 and 808-2). FIG. 14 illustrates a local routing scenario in an illustrative embodiment. Communication controller 1004 of NTN satellite 804 stores a UE context 1402 for each of UEs 106-1 and 106-2, which are indicated as UE context 1402-1 and UE context 1402-2. A UE context 1402 is a block of information associated with an (one) active UE 106. The block of information may contain the information required to maintain the 5G services towards the active UE 106. For example, the UE context 1402 may contain UE state information, security information, UE capability information, identities, etc.

In FIG. 13, communication controller 1004 of NTN satellite 804 receives and/or stores a UE context mapping 1404 between the UE context 1402-1 of UE 106-1 and the UE context 1402-2 of UE 106-2 (step 1302). For example, communication controller 1004 may receive a context management message from an AMF 212 indicating the UE context mapping 1404 (optional step 1303). A UE context mapping 1404 (also referred to as UE context mapping information, a UE context mapping configuration, etc.) comprises information that associates one UE context 1402 with another UE context 1402. A UE context mapping 1404 may be stored in/with a UE context 1402. For example, a UE context mapping 1404 to the UE context 1402-2 associated with UE 106-2 may be stored in the UE context 1402-1 associated with UE 106-1, and vice-versa.

Communication controller 1004 receives an incoming communication comprising one or more data packets 940 from UE 106-1 over service link 808-1 (step 1304). The data packets 940 are addressed to or destined for UE 106-2. The data packets 940 may comprise RRC signaling 1410 or UP traffic 1412, for example. In response to receiving a data packet 940, communication controller 1004 may verify integrity of the data packet 940 (if integrity protected) based on an integrity key indicated in the UE context 1402-1 of UE 106-1, and/or decrypt the data packet 940 (if encrypted) based on an encryption key indicated in the UE context 1402-1 of UE 106-1 (optional step 1306).

Communication controller 1004 determines whether to perform local routing of the data packet 940 (step 1308), without routing to the network (e.g., 5GC 104). For example, communication controller 1004 may process the UE context 1402 for UE 106-1 and/or UE 106-2 to determine whether local routing is allowed or available, may determine the state or availability of feeder link 806, may determine the state or availability of the service link 808-2 to UE 106-2, may process a local configuration or policy, and/or may process other information to determine whether to perform local routing. In response to a determination not to perform local routing, communication controller 1004 routes, sends, or forwards the data packet 940 to the network (e.g., NTN gateway 802, 5GC 104, etc.) over feeder link 806 (step 1310).

In response to a determination to perform local routing, communication controller 1004 routes, sends, or forwards the data packet 940 to UE 106-2 over service link 808-2 based on the UE context mapping 1404 (step 1314). When local routing is performed in this manner, the communication controller 1004 does not route the data packet 940 to the network, as the data packet 940 is routed directly to UE 106-2 over service link 808-2. When directly routing the data packet 940, communication controller 1004 may integrity protect the data packet 940 based on an integrity key indicated in the UE context 1402-2 of UE 106-2, and/or may encrypt the data packet 940 based on an encryption key indicated in the UE context 1402-2 of UE 106-2 (optional step 1312).

In an embodiment, communication controller 1004 determines whether to perform local routing based on the state of the feeder link 806. FIG. 15 is a flow chart illustrating a method of determining whether to perform local routing in an illustrative embodiment. Communication controller 1004 determines whether the feeder link 806 to the network (e.g., 5GC 104) is available (step 1502). Feeder link 806 may become unavailable or disconnected due to movement of the NTN satellite 804, hardware or software interruptions, weather, and/or other conditions. When the feeder link 806 is unavailable, communication controller 1004 makes a determination or decides to perform local routing (step 1504). When the feeder link 806 is available, communication controller 1004 makes a determination or decides to perform home network routing by routing the data packet 940 to the network over the feeder link 806 (step 1506).

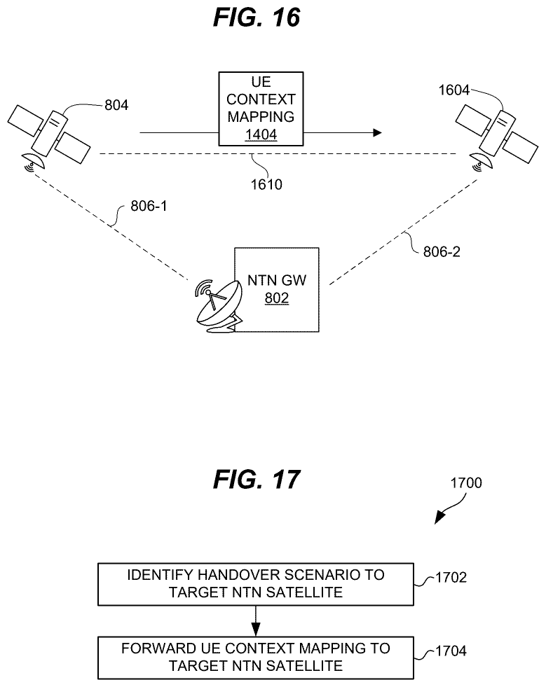

In an embodiment, NTN satellite 804 is configured to forward the UE context mapping 1404 to another NTN satellite 804 for mobility scenarios. For example, the NTN satellite 804 may be moving and/or UEs 106 may be moving so that NTN satellite 804 becomes unable to serve UEs 106. FIG. 16 illustrates inter-satellite communication in an illustrative embodiment. It is assumed in FIG. 16 that NTN satellite 804 hands off sessions of UE 106-1 and 106-2 to a target NTN satellite 1604. FIG. 17 is a flow chart illustrating a method 1700 of forwarding a UE context mapping 1404 in a mobility scenario in an illustrative embodiment. Communication controller 1004 identifies a handover scenario to another (target) NTN satellite 1604 (step 1702). For example, when UE coverage to UE 106-1 and 106-2 has diminished below a threshold, communication controller 1004 may initiate a handover to target NTN satellite 1604. Communication controller 1004 forwards the UE context mapping 1404 to the target NTN satellite 1604 (step 1704). For example, communication controller 1004 may forward the UE context mapping 1404 to target NTN satellite 1604 over an inter-satellite link 1610. In another example, communication controller 1004 may forward the UE context mapping 1404 to target NTN satellite 1604 over feeder links 806 (i.e., feeder link 806-1 and 806-2) and NTN gateway 802. Communication controller 1004 may forward the UE contexts 1402 for UEs 106 to target NTN satellite 1604 (in step 1704), which also includes the UE context mapping 1404.

### Control Plane

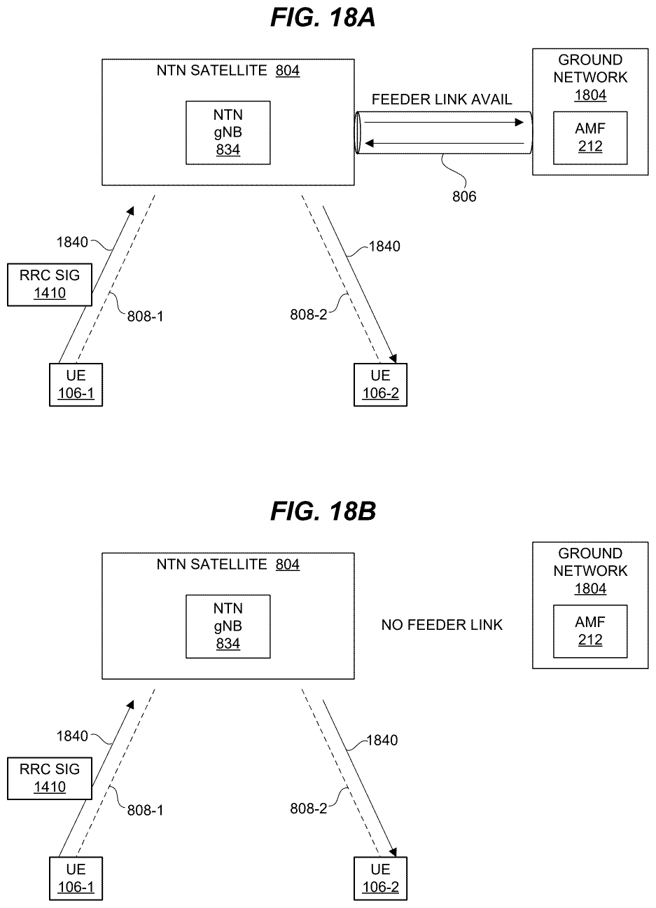

FIGS. 18A-18B illustrate local routing of control plane messages in an illustrative embodiment. In FIG. 18A, UE 106-1 sends a (uplink) control plane message 1840 (e.g., RRC signaling 1410) to NTN satellite 804 over service link 808-1. The NTN gNB 834 of NTN satellite 804 receives a control plane message 1840, and may verify the integrity of the control plane message 1840 (if integrity protected) based on an integrity key indicated in the UE context 1402-1 of UE 106-1. NTN gNB 834 may also decrypt the control plane message 1840 (if encrypted) based on an encryption key indicated in the UE context 1402-1 of UE 106-1. NTN gNB 834 determines whether to perform local routing of the control plane message 1840. For example, NTN gNB 834 determines whether the feeder link 806 to the ground network 1804 (e.g., NTN gateway 802 and/or 5GC 104) is available. In this embodiment, the feeder link 806 is available so NTN gNB 834 forwards the control plane message 1840 to the ground network 1804 (e.g., AMF 212) over the feeder link 806. NTN gNB 834 may integrity protect and/or encrypt the control plane message 1840 based on an integrity key and encryption key indicated in the UE context 1402-1 of UE 106-1 before sending over the feeder link 806. AMF 212 processes the control plane message 1840, and sends the control plane message 1840 over the feeder link 806 to NTN gNB 834. The NTN gNB 834 receives the control plane message 1840, and may verify the integrity of the control plane message 1840 (if integrity protected) based on an integrity key indicated in the UE context 1402-2 of UE 106-2. NTN gNB 834 may also decrypt the control plane message 1840 (if encrypted) based on an encryption key indicated in the UE context 1402-2 of UE 106-2. NTN gNB 834 forwards the (downlink) control plane message 1840 to UE 106-2 over the service link 808-2. NTN gNB 834 may integrity protect and/or encrypt the control plane message 1840 based on an integrity key and encryption key indicated in the UE context 1402-2 of UE 106-2 before sending over the service link 808-2.

In FIG. 18B, the feeder link 806 is not available so NTN gNB 834 forwards the (downlink) control plane message 1840 to UE 106-2 over the service link 808-2. NTN gNB 834 may integrity protect and/or encrypt the control plane message 1840 based on an integrity key and encryption key indicated in the UE context 1402-2 of UE 106-2 before sending over the service link 808-2. One technical benefit is the NTN satellite 804 may directly route the control plane message 1840 to UE 106-2 without going through the ground network 1804.

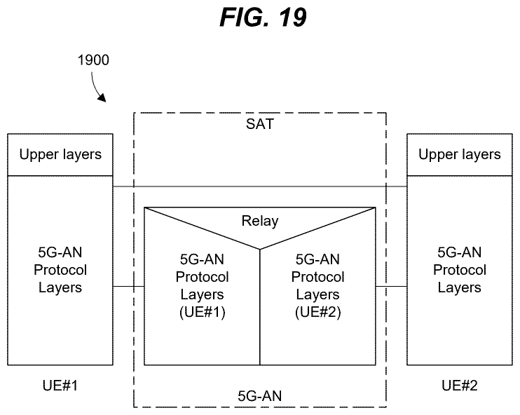

FIG. 19 illustrates a control plane protocol stack 1900 in an illustrative embodiment. The control plane protocol stack 1900 allows for a 5G Access Network (5G-AN) (e.g., NTN gNB 834 on board NTN satellite 804) to locally route control plane messages 1840 between two UEs 106. Control plane protocol stack 1900 may comprise an enhancement or extension to 3GPP TS 23.501 (section 8.2).

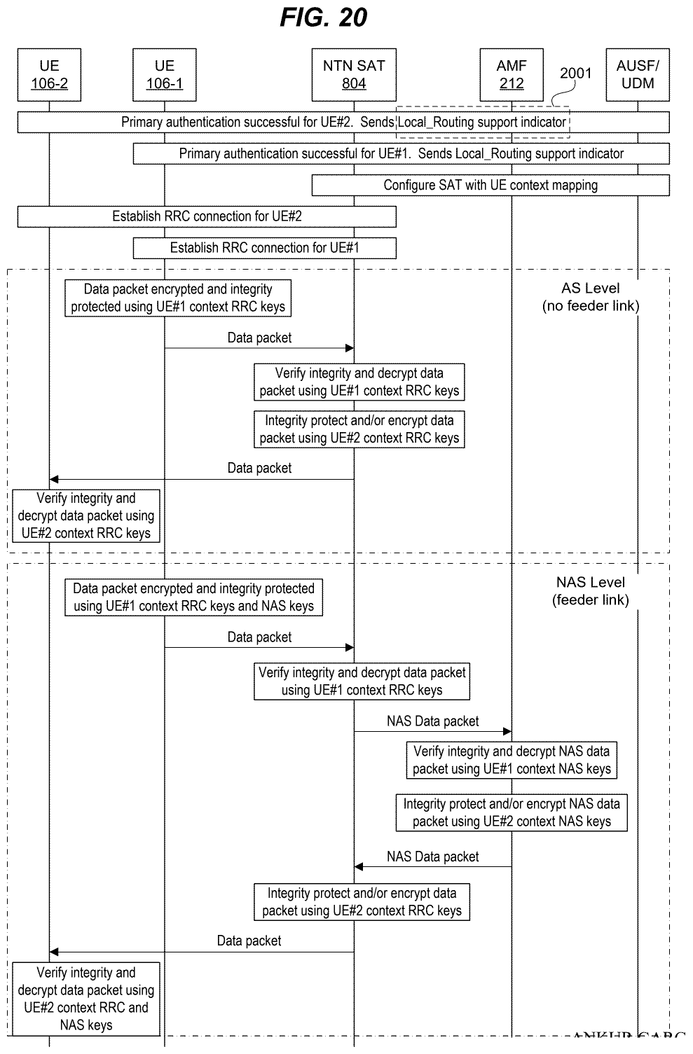

FIG. 20 is a message diagram illustrating local routing of control plane messages in an illustrative embodiment. UE 106-2 (also referred to as UE #2) performs primary authentication, and sends a local routing support indicator 2001 to the network during the initial registration procedure, and may also send location information. The local routing support indicator 2001 indicates whether a UE supports local routing of data packets, whether a subscription associated with a UE allows for local routing, etc. The local routing support indicator 2001 may also be referred to as a DATA_EXCHANGE_AT_SAT_LEVEL flag, a LOCAL_DATA_EXCHANGE support flag, etc. When primary authentication of UE 106-2 is successful, UDM 218 authorizes the data exchange at the satellite level. Similarly, UE 106-1 (also referred to as UE #1) performs primary authentication, and sends a local routing support indicator 2001 to the network during the initial registration procedure, and may also send location information. When primary authentication of UE 106-1 is successful, UDM 218 authorizes the data exchange at the satellite level.

The network configures the NTN satellite 804 with a UE context mapping 1404 between the UE context 1402-1 of UE 106-1 and the UE context 1402-2 of UE 106-2. For example, AMF 212 may send a context management message to NTN satellite 804 indicating the UE context mapping 1404, such as an initial context setup request. UE 106-1 and UE 106-2 establish individual RRC connections with NTN satellite 804 for data exchange. NTN satellite 804 will enable local data exchange based on the UE context mapping 1404.

When UE 106-1 initiates communication of a data packet to UE 106-2, UE 106-1 encrypts and integrity protects the data packet using RRC keys (i.e., the K_{RRCint} key 710 and K_{RRCenc} key 711) for UE 106-1. UE 106-1 sends the encrypted data packet (i.e., RRC packet) to NTN satellite 804 via service link 808-1.

In response to receiving the data packet, NTN satellite 804 (i.e., NTN gNB 834) verifies the integrity of the data packet based on the RRC integrity key and decrypts the data packet based on the RRC encryption key indicated in the UE context 1402-1 of UE 106-1. NTN satellite 804 determines whether to perform local routing of the data packet. When the feeder link 806 is unavailable, NTN satellite 804 determines that local routing or local exchange of the data packet is activated or enabled based on the UE context mapping 1404. NTN satellite 804 integrity protects the data packet based on an RRC integrity key and encrypts the data packet based on the RRC encryption key indicated in the UE context 1402-2 of UE 106-2. NTN satellite 804 then routes, sends, or forwards the data packet to UE 106-2 over service link 808-2 based on the UE context mapping 1404. When local routing is performed in this manner, NTN satellite 804 does not route the data packet to the network, as the data packet is routed directly to UE 106-2 over service link 808-2. UE 106-2 verifies the integrity of the data packet and decrypts the data packet based on the RRC keys. One technical benefit is the NTN satellite 804 directly routes the data packet to UE 106-2 without going through the network. Thus, the data packet may be routed to UE 106-2 even when the feeder link 806 is disconnected.

When the feeder link 806 is available, NTN satellite 804 determines that local routing or local exchange of the data packet is inactive or disabled, and home network routing is activated. NTN satellite 804 integrity protects the data packet based on a NAS integrity key (e.g., K_{NASint} 706) and encrypts the data packet based on the NAS encryption key (e.g., K_{NASenc} 707) indicated in the UE context 1402-1 of UE 106-1. NTN satellite 804 then routes, sends, or forwards the data packet to AMF 212 over feeder link 806. AMF 212 verifies the integrity of the data packet based on the NAS integrity key and decrypts the data packet based on the NAS encryption key indicated in the UE context 1402-1 of UE 106-1. AMF 212 then integrity protects the data packet based on a NAS integrity key and encrypts the data packet based on the NAS encryption key indicated in the UE context 1402-2 of UE 106-2, and sends the data packet to NTN satellite 804 over feeder link 806. NTN satellite 804 verifies the integrity of the data packet based on NAS integrity key indicated in the UE context 1402-2 of UE 106-2, and encrypts the data packet based on the RRC encryption key indicated in the UE context 1402-2 of UE 106-2. NTN satellite 804 then routes, sends, or forwards the data packet to UE 106-2 over service link 808-2. UE 106-2 verifies the integrity of the data packet and decrypts the data packet based on the RRC and NAS keys.

### User Plane

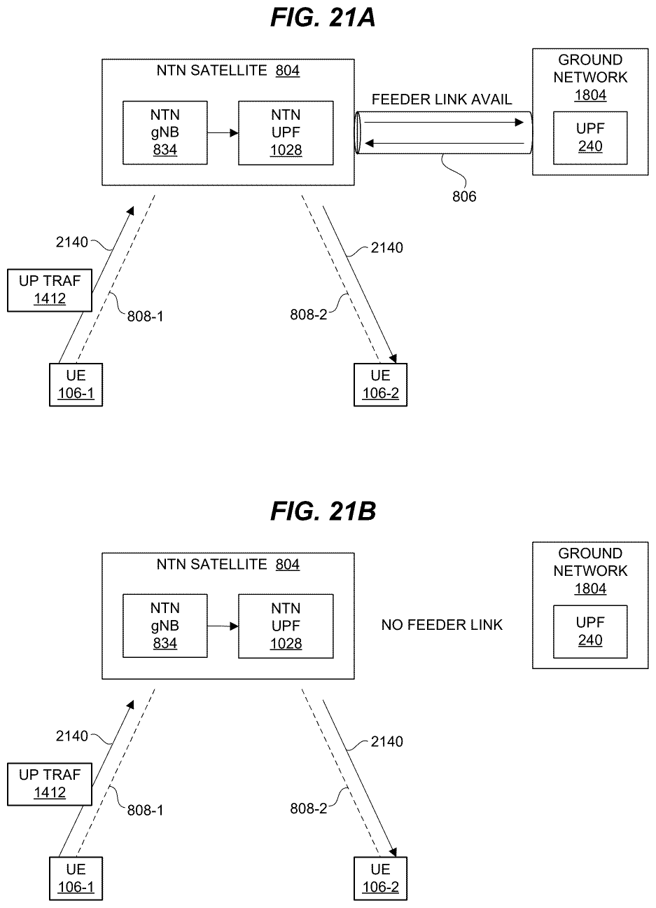

FIGS. 21A-21B illustrate local routing of user plane messages in an illustrative embodiment. In FIG. 21A, UE 106-1 sends a (uplink) user plane message 2140 (e.g., UP traffic 1412) to NTN satellite 804 over service link 808-1. The NTN gNB 834 of NTN satellite 804 receives a user plane message 2140, and forwards the user plane message 2140 to NTN UPF 1028. NTN UPF 1028 may verify the integrity of the user plane message 2140 (if integrity protected) based on an integrity key indicated in the UE context 1402-1 of UE 106-1. NTN UPF 1028 may also decrypt the user plane message 2140 (if encrypted) based on an encryption key indicated in the UE context 1402-1 of UE 106-1. NTN UPF 1028 determines whether to perform local routing of the user plane message 2140. For example, NTN UPF 1028 determines whether the feeder link 806 to the ground network 1804 (e.g., NTN gateway 802 and/or 5GC 104) is available. In this embodiment, the feeder link 806 is available so NTN UPF 1028 forwards the user plane message 2140 to the ground network 1804 (e.g., UPF 240) over the feeder link 806. NTN UPF 1028 may integrity protect and/or encrypt the user plane message 2140 based on an integrity key and encryption key indicated in the UE context 1402-1 of UE 106-1 before sending over the feeder link 806. UPF 240 processes the user plane message 2140, and sends the user plane message 2140 over the feeder link 806 to NTN UPF 1028. NTN UPF 1028 receives the user plane message 2140, and may verify the integrity of the user plane message 2140 (if integrity protected) based on an integrity key indicated in the UE context 1402-2 of UE 106-2. NTN UPF 1028 may also decrypt the user plane message 2140 (if encrypted) based on an encryption key indicated in the UE context 1402-2 of UE 106-2. NTN UPF 1028 forwards the (downlink) user plane message 2140 to UE 106-2 over the service link 808-2. NTN UPF 1028 may integrity protect and/or encrypt the user plane message 2140 based on an integrity key and encryption key indicated in the UE context 1402-2 of UE 106-2 before sending over the service link 808-2.

In FIG. 21B, the feeder link 806 is not available so NTN UPF 1028 forwards the (downlink) user plane message 2140 to UE 106-2 over the service link 808-2. NTN UPF 1028 may integrity protect and/or encrypt the user plane message 2140 based on an integrity key and encryption key indicated in the UE context 1402-2 of UE 106-2 before sending over the service link 808-2. One technical benefit is the NTN satellite 804 may directly route the user plane message 2140 to UE 106-2 without going through the ground network 1804.

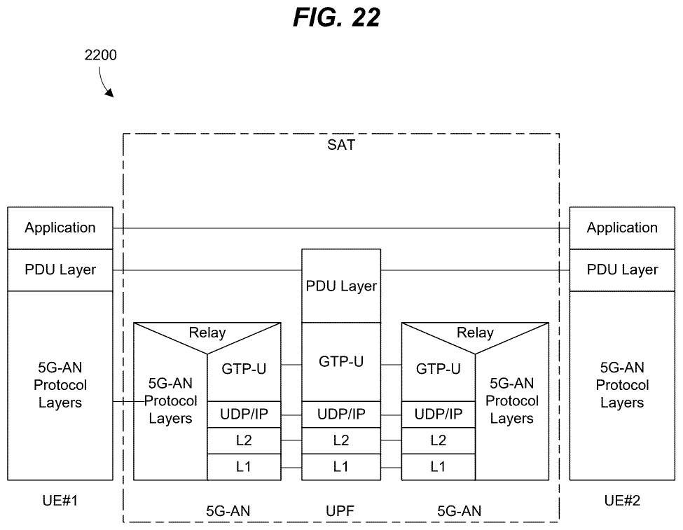

FIG. 22 illustrates a user plane protocol stack 2200 in an illustrative embodiment. The user plane protocol stack 2200 allows for a 5G-AN (e.g., NTN UPF 1028 on board NTN satellite 804) to locally route user plane messages between two UEs 106. The 5G-AN shown twice is the same instance but for clarity is shown as two 5G-AN towards both UEs. User plane protocol stack 2200 may comprise an enhancement or extension to 3GPP TS 23.501 (section 8.2).

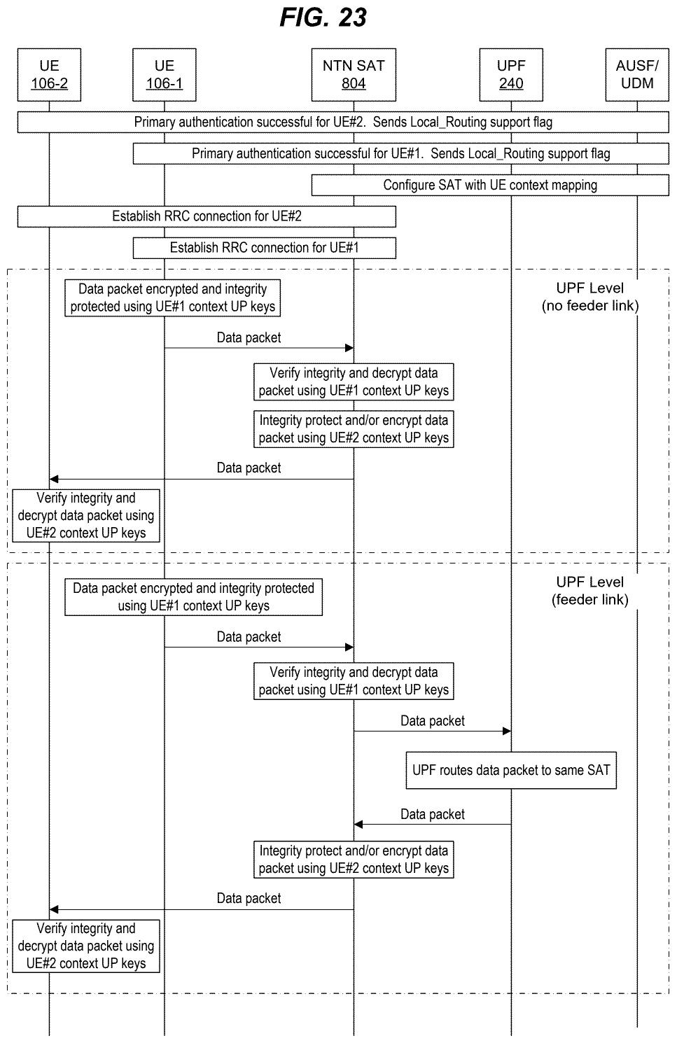

FIG. 23 is a message diagram illustrating local routing of user plane messages in an illustrative embodiment. When UE 106-1 initiates communication of a data packet (i.e., a user plane packet 2140) to UE 106-2, UE 106-1 encrypts and integrity protects the data packet using UP keys (i.e., K_{UPint} key 712 and K_{UPenc} key 713) for UE 106-1. UE 106-1 sends the encrypted data packet to NTN satellite 804 via service link 808-1.

In response to receiving the data packet, NTN satellite 804 (i.e., NTN UPF 1028) verifies the integrity of the data packet based on the UP integrity key and decrypts the data packet based on the UP encryption key indicated in the UE context 1402-1 of UE 106-1. NTN satellite 804 determines whether to perform local routing of the data packet. When the feeder link 806 is unavailable, NTN satellite 804 determines that local routing or local exchange of the data packet is activated or enabled based on the UE context mapping 1404. NTN satellite 804 integrity protects the data packet based on an UP integrity key and encrypts the data packet based on the UP encryption key indicated in the UE context 1402-2 of UE 106-2. NTN satellite 804 then routes, sends, or forwards the data packet to UE 106-2 over service link 808-2 based on the UE context mapping 1404. When local routing is performed in this manner, NTN satellite 804 does not route the data packet to the ground network, as the data packet is routed directly to UE 106-2 over service link 808-2. UE 106-2 verifies the integrity of the data packet and decrypts the data packet based on the UP keys. One technical benefit is the NTN satellite 804 directly routes the data packet to UE 106-2 without going through the network. Thus, the data packet may be routed to UE 106-2 even when feeder link 806 is disconnected.

When the feeder link 806 is available, NTN satellite 804 determines that local routing or local exchange of the data packet is inactive or disabled, and home network routing is activated. NTN satellite 804 integrity protects and encrypts the data packet based on UP keys indicated in the UE context 1402-1 of UE 106-1. NTN satellite 804 then routes, sends, or forwards the data packet to UPF 240 over feeder link 806. UPF 240 verifies the integrity of the data packet based on the UP integrity key and decrypts the data packet based on the UP encryption key indicated in the UE context 1402-1 of UE 106-1. UPF 240 then integrity protects the data packet based on a UP integrity key and encrypts the data packet based on the UP encryption key indicated in the UE context 1402-2 of UE 106-2, and sends the data packet to NTN satellite 804 over feeder link 806. NTN satellite 804 verifies the integrity of the data packet based on the UP integrity key indicated in the UE context 1402-2 of UE 106-2, and encrypts the data packet based on the UP encryption key indicated in the UE context 1402-2 of UE 106-2. NTN satellite 804 then forwards, sends, or routes the data packet to UE 106-2 over service link 808-2. UE 106-2 verifies the integrity of the data packet and decrypts the data packet based on the UP keys.

### Mapping Configuration

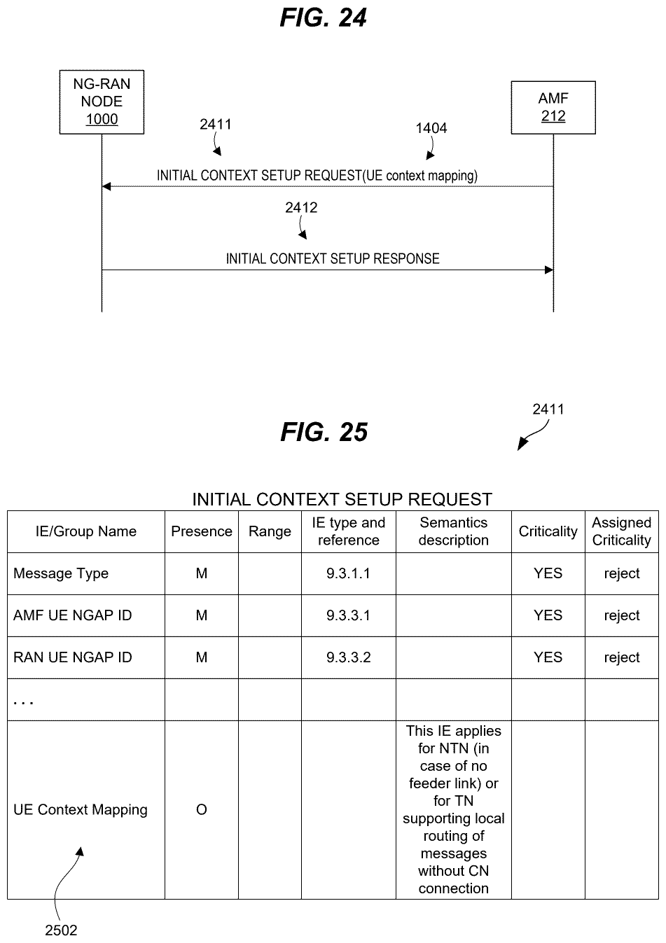

AMF 212 of the 5G system 100 may configure the NTN satellite 804 (or other NG-RAN nodes 1000) with UE context mappings 1404, such as by sending context management messages to the NTN satellite 804. For example, AMF 212 may use the UE context management procedures as described in 3GPP TS 38.413 (v17.6.0), which is incorporated by reference as if fully included herein, to provide UE context mappings 1404 to NG-RAN nodes 1000. FIG. 24 illustrates an initial context setup procedure in an illustrative embodiment. In an embodiment, the initial context setup procedure described in section 8.3.1.1 of 3GPP TS 38.413 may be extended to indicate a UE context mapping 1404. The purpose of the initial context setup procedure is to establish the necessary overall initial UE context at the NG-RAN node 1000, when required, including PDU session context, the security key, mobility restriction list, UE radio capability and UE security capabilities, etc. AMF 212 sends an initial context setup request message 2411 to the NG-RAN node 1000 (e.g., NTN satellite 804). In an embodiment, the initial context setup request message 2411 contains the UE context mapping 1404 between UE contexts 1402. Upon receipt of the initial context setup request message 2411, NG-RAN node 1000 stores the UE context mapping 1404 in the UE contexts 1402 of the applicable UEs 106. The UE context mapping 1404 may be used when a feeder link 806 towards AMF 212 or 5GC 104 is lost or unavailable in case of an NTN satellite 804. The UE context mapping 1404 may also be used in terrestrial networks. Upon successful operation, NG-RAN node 1000 responds to AMF 212 with an initial context setup response message 2412. One technical benefit is AMF 212 is able to configure an NG-RAN node 1000 with a UE context mapping 1404 using an enhanced initial context setup procedure.

FIG. 25 illustrates an initial context setup request message 2411 in an illustrative embodiment. As indicated in section 9.2.2.1 of 3GPP TS 38.413, the message content of the initial context setup request message 2411 includes Information Elements (IE), such as Message Type, AMF UE NG Application Protocol (NGAP) ID, RAN UE NGAP ID, etc. In an embodiment, the initial context setup request message 2411 may be extended to include a UE context mapping IE 2502 that carries or contains a UE context mapping 1404. One technical benefit is the initial context setup request message 2411 is able to indicate a UE context mapping 1404 to an NG-RAN node 1000.

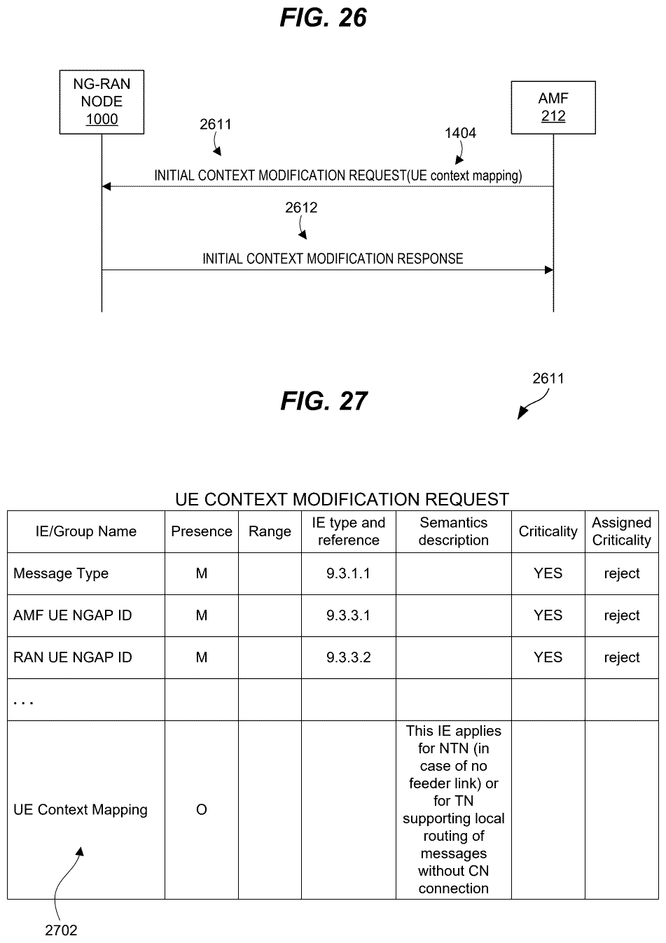

FIG. 26 illustrates a UE context modification procedure in an illustrative embodiment. In an embodiment, the UE context modification procedure described in section 8.3.4.2 of 3GPP TS 38.413 may be extended to indicate a UE context mapping 1404. The purpose of the UE context modification procedure is to partly modify the established UE context, and uses UE-associated signaling. AMF 212 sends a UE context modification request message 2611 to the NG-RAN node 1000 (e.g., NTN satellite 804). In an embodiment, the UE context modification request message 2611 contains an update or modification to a UE context mapping 1404. For example, if there is a feeder link 806, AMF 212 may disable a UE context mapping 1404 between two UE contexts (i.e., indicate the mapping as “not allowed”). Upon successful operation, NG-RAN node 1000 responds to AMF 212 with a UE context modification response 2612. One technical benefit is AMF 212 is able to modify a UE context mapping 1404 in an NG-RAN node 1000 using an enhanced UE context modification procedure.

FIG. 27 illustrates a UE context modification request message 2611 in an illustrative embodiment. As indicated in section 9.2.2.7 of 3GPP TS 38.413, the message content of the UE context modification request message 2611 includes IEs, such as Message Type, AMF UE NGAP ID, RAN UE NGAP ID, etc. In an embodiment, the UE context modification request message 2611 may be extended to include a UE context mapping IE 2702 that modifies a UE context mapping 1404. One technical benefit is UE context modification request message 2611 is able to modify a UE context mapping 1404 at an NG-RAN node 1000.

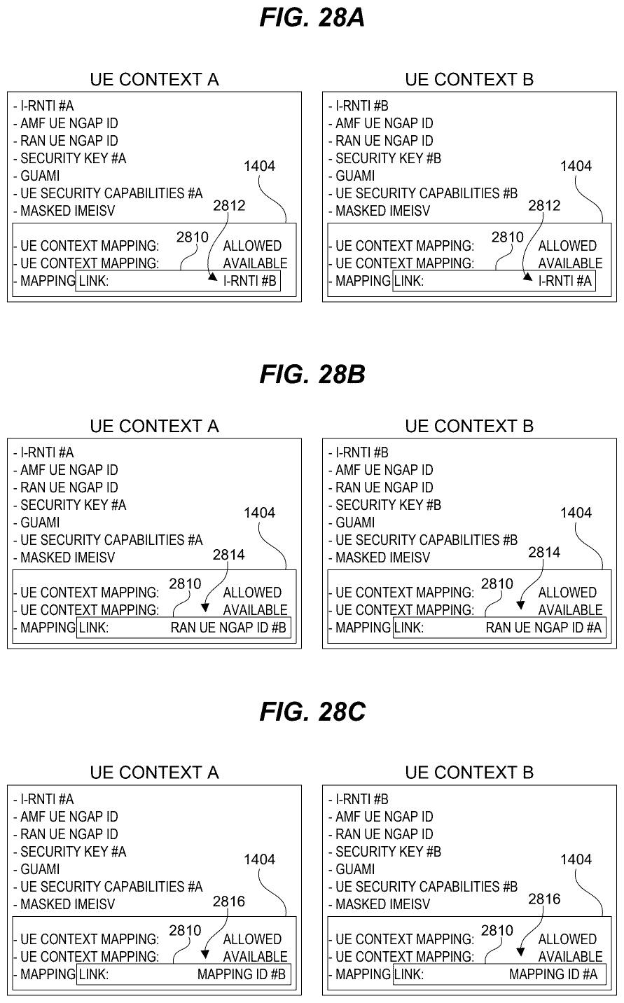

FIGS. 28A-28C illustrate mapping of UE contexts 1402 in illustrative embodiments. FIGS. 28A-28C illustrate UE contexts 1402 for UE 106-1 and UE 106-2 (i.e., UE context A and UE context B). A UE context mapping 1404 is stored in each UE context 1402. For example, UE context mapping 1404 may indicate whether local routing is allowed for a corresponding UE 106, whether a mapping is available, and if available, a mapping link 2810 or mapping configuration to another UE context 1402. In FIG. 28A, for example, the mapping link 2810 may comprise a Radio Network Temporary Identifier (RNTI) 2812 associated with another UE context 1402 or assigned to another UE 106. In FIG. 28B, for example, the mapping link 2810 may comprise a UE RAN ID 2814 (i.e., RAN UE NGAP ID) associated with another UE context 1402 or assigned to another UE 106. In FIG. 28C, for example, the mapping link 2810 may comprise a newly-defined mapping ID 2816 associated with another UE context 1402 or assigned to another UE 106. Although examples are given in FIGS. 28A-28C, UE contexts 1402 and UE context mappings 1404 may contain other information as desired.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof.

I/We claim:

1. An apparatus of a radio access network, the apparatus comprising:
a non-terrestrial network satellite operatively coupled to first user equipment and second user equipment;
the non-terrestrial network satellite comprising at least one processor, and at least one memory storing instructions that, when executed by the at least one processor, cause the non-terrestrial network satellite at least to:
store a user equipment context mapping between a first user equipment context of the first user equipment and a second user equipment context of the second user equipment;
receive a data packet from the first user equipment over a first service link;
determine whether to perform local routing of the data packet without routing to a ground network; and
send, in response to a determination to perform local routing, the data packet to the second user equipment over a second service link based on the user equipment context mapping.

2. The apparatus of claim 1, wherein the at least one processor further causes the non-terrestrial network satellite at least to:
determine whether a feeder link to the ground network is available; and
decide to perform the local routing when the feeder link is unavailable.

3. The apparatus of claim 1, wherein the at least one processor further causes the non-terrestrial network satellite at least to:
integrity protect the data packet based on an integrity key indicated in the second user equipment context of the second user equipment before sending to the second user equipment.

4. The apparatus of claim 1, wherein the at least one processor further causes the non-terrestrial network satellite at least to:
encrypt the data packet based on an encryption key indicated in the second user equipment context of the second user equipment before sending to the second user equipment.

5. The apparatus of claim 1, wherein:
the data packet comprises one of radio resource control signaling or user plane traffic.

6. The apparatus of claim 1, wherein the at least one processor further causes the non-terrestrial network satellite at least to:
receive a context management message of a context management procedure from an access and mobility management function indicating the user equipment context mapping;
wherein the context management procedure comprises an initial context setup procedure.

7. The apparatus of claim 6, wherein:
an initial context setup request message of the initial context setup procedure is extended to include an information element containing the user equipment context mapping.

8. The apparatus of claim 1, wherein:
the user equipment context mapping includes a mapping link from the first user equipment context to the second user equipment context; and
the mapping link comprises a radio network temporary identifier assigned to the second user equipment.

9. The apparatus of claim 1, wherein:
the user equipment context mapping includes a mapping link from the first user equipment context to the second user equipment context; and
the mapping link comprises a user equipment radio access network identifier assigned to the second user equipment.

10. The apparatus of claim 1, wherein the at least one processor further causes the non-terrestrial network satellite at least to:
identify a handover scenario to another non-terrestrial network satellite; and
forward the user equipment context mapping to the other non-terrestrial network satellite over an inter-satellite link.

11. A method of performing local routing in a radio access network, the method comprising:
storing, at a non-terrestrial network satellite operatively coupled to first user equipment and second user equipment, a user equipment context mapping between a first user equipment context of the first user equipment and a second user equipment context of the second user equipment;
receiving, at the non-terrestrial network satellite, a data packet from the first user equipment over a first service link;
determining, at the non-terrestrial network satellite, whether to perform local routing of the data packet without routing to a ground network; and
sending, in response to a determination to perform local routing, the data packet from the non-terrestrial network satellite to the second user equipment over a second service link based on the user equipment context mapping.

12. The method of claim 11, wherein the determining whether to perform local routing of the data packet comprises:
determining whether a feeder link to the ground network is available; and
deciding to perform the local routing when the feeder link is unavailable.

13. The method of claim 11, further comprising:
integrity protecting the data packet based on an integrity key indicated in the second user equipment context of the second user equipment before sending to the second user equipment.

14. The method of claim 11, further comprising:
encrypting the data packet based on an encryption key indicated in the second user equipment context of the second user equipment before sending to the second user equipment.

15. The method of claim 11, wherein:
the data packet comprises one of radio resource control signaling or user plane traffic.

16. The method of claim 11, further comprising:
receiving a context management message of a context management procedure from an access and mobility management function indicating the user equipment context mapping;
wherein the context management procedure comprises an initial context setup procedure.

17. The method of claim 16, wherein:
an initial context setup request message of the initial context setup procedure is extended to include an information element containing the user equipment context mapping.

18. The method of claim 11, wherein:
the user equipment context mapping includes a mapping link from the first user equipment context to the second user equipment context; and
the mapping link comprises a radio network temporary identifier assigned to the second user equipment.

19. The method of claim 11, wherein:
the user equipment context mapping includes a mapping link from the first user equipment context to the second user equipment context; and
the mapping link comprises a user equipment radio access network identifier assigned to the second user equipment.

20. The method of claim 11, further comprising:
identifying a handover scenario to another non-terrestrial network satellite; and
forwarding the user equipment context mapping to the other non-terrestrial network satellite over an inter-satellite link.
